(19) United States
(12) Patent Application Publication
(10) Pub. No.: US 2016/0259579 A1
(43) Pub. Date: Sep. 8, 2016

(54) STORAGE CONTROL APPARATUS AND STORAGE CONTROL METHOD

(71) Applicant: FUJITSU LIMITED, Kawasaki-shi (JP)

(72) Inventors: Goro Yamada, Adachi (JP); Yoshimasa MISHUKU, Yokohama (JP); Tomoaki Sasaki, Minato (JP); Nina Tsukamoto, Koto (JP)

(73) Assignee: FUJITSU LIMITED, Kawasaki-shi (JP)

(21) Appl. No.: 15/012,064

(22) Filed: Feb. 1, 2016

(30) Foreign Application Priority Data
Mar. 2, 2015 (JP) 2015-040777

(51) Int. Cl. G06F 3/06

(52) U.S. Cl. CPC G06F 3/0619; G06F 3/065; G06F 3/0673

(57) ABSTRACT

A processor generates, according to difference information that represents a difference between stationary points in a volume that represents a management unit for a storage area and that is associated with a plurality of generations, aggregate information in which the difference information for the plurality of generations is aggregated. The processor is configured to associate the aggregate information with a state of the volume at an oldest stationary point. The processor is configured to associate update information for a volume that has been updated from a state of the volume at a latest stationary point.

### CROSS-REFERENCE TO RELATED APPLICATIONS

This application is based upon and claims the benefit of priority of the prior Japanese Patent Application No. 2015-040777, filed on Mar. 2, 2015, the entire contents of which are incorporated herein by reference.

### FIELD

The embodiments discussed herein are related to a storage control apparatus, a storage control method, and a storage control program.

### BACKGROUND

Snapshot is one of a data recording system. In snapshot, it is possible to accept a new Input/Output (I/O) while maintaining data at a prescribed stationary point. Accordingly, snapshot makes it possible to refer to and update latest data and to refer to data at the stationary point.

As an example of a snapshot, there is a system in which the storage capacity and the processing overhead are reduced by maintaining the difference (referred to as a COW (Copy-On-Write) in the explanation below) between data at a stationary point and the latest data. This sort of snapshot data management method is roughly divided into the following two types. That is, in one of the data management methods, data of all volumes are kept in a prescribed storage area (referred to as the base Logical Unit Number (LUN) below) for the latest data, and a COW is kept as the difference for each stationary point. In this management method, with respect to data that have been changed due to an update in the base LUN, the data before the change are stored in the COW. In another data management method, the oldest data of a volume are all stored in the base LUN, and a COW is kept as the difference for each stationary point. In this management method, with respect to data that have been changed due to the update in the base LUN, the data after the change are stored in the COW.

In either of the methods mentioned above, snapshots may be obtained a plurality of times for one volume. In the explanation below, the unit in which one snapshot is specified from a series of snapshots obtained from the same volume (referred to as a target volume below) is referred to as a “generation”.

Note that related technologies are described for example in Japanese Laid-open Patent Publication No. 2014-6845 and Japanese Laid-open Patent Publication No. 2002-278819.

### SUMMARY

According to an aspect of the embodiments, a storage control apparatus includes a processor and the processor generates, according to difference information that represents a difference between stationary points in a volume that represents a management unit for a storage area and that is associated with a plurality of generations, aggregate information in which the difference information for the plurality of generations is aggregated. The processor is configured to associate the aggregate information with a state of the volume at an oldest stationary point. The processor is configured to associate update information for a volume that has been updated from a state of the volume at a latest stationary point.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of the configuration of a storage control apparatus according to an embodiment;

FIGS. 2A-2B are explanatory diagrams for the creation of a COW in the first comparison example;

FIG. 3 is an explanatory diagram for the writing of data in the first comparison example;

FIG. 4 is an explanatory diagram for the reading of data in the first comparison example;

FIGS. 5A-5B are explanatory diagrams for the creation of a COW in the second comparison example;

FIG. 6 is an explanatory diagram for the writing of data in the second comparison example;

FIG. 7 is an explanatory diagram for the reading of data in the second comparison example;

FIG. 8 illustrates an example of the configuration of a storage apparatus according to an embodiment;

FIG. 9 illustrates an example of the snapshot management structure according to an embodiment;

FIG. 10 illustrates an example of the data structure of a COW;

FIG. 11 illustrates an example of the configuration of difference information.

FIG. 12 is an explanatory diagram for the writing of data according to an embodiment;

FIG. 13 is an explanatory diagram for the reading of data according to an embodiment;

FIG. 14 is a comparison diagram for the reading and writing performances in the comparison examples and in an embodiment;

FIGS. 15A-15D are explanatory diagrams for the creation of a COW in an embodiment;

FIG. 16 is an example of a flowchart illustrating the details of a COW generation process;

FIGS. 17A-17D are explanatory diagrams for a restore according to an embodiment;

FIGS. 18A-18C are explanatory diagrams of a merge process in a restore according to an embodiment;

FIG. 19 is an example of a flowchart illustrating details of a restore process;

FIG. 20 is an example of a flowchart illustrating details of a merge process in a restore process;

FIGS. 21A-21D are explanatory diagrams for a switching process from a management form 2 to a management form 1 according to an embodiment;

FIG. 22 is an example of a flowchart illustrating details of a switching process from a management form 2 to a management form 1;

FIGS. 23A-23C are explanatory diagrams for a switching process from a management form 1 to a management form 2 according to an embodiment;

FIG. 24 is an example of a flowchart illustrating details of a switching process from a management form 1 to a management form 2;

FIG. 25 is an example of a flowchart illustrating details of a reading process according to an embodiment; and

FIG. 26 illustrates an example of the hardware configuration of a storage apparatus according to an embodiment.

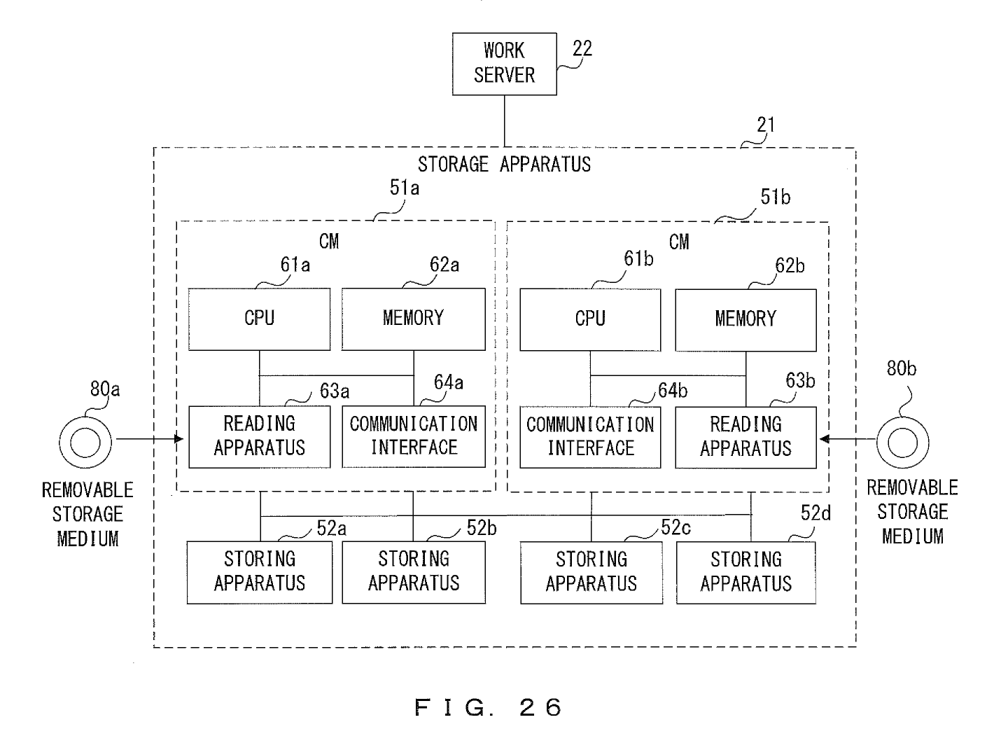

### DESCRIPTION OF EMBODIMENTS

When snapshots are repeatedly obtained and the number of generations increases, the access performance deteriorates.

Therefore, in an aspect, an objective of the present invention is to provide a technique for obtaining snapshots for suppressing the deterioration in the access performance due to the increase in the number of generations.

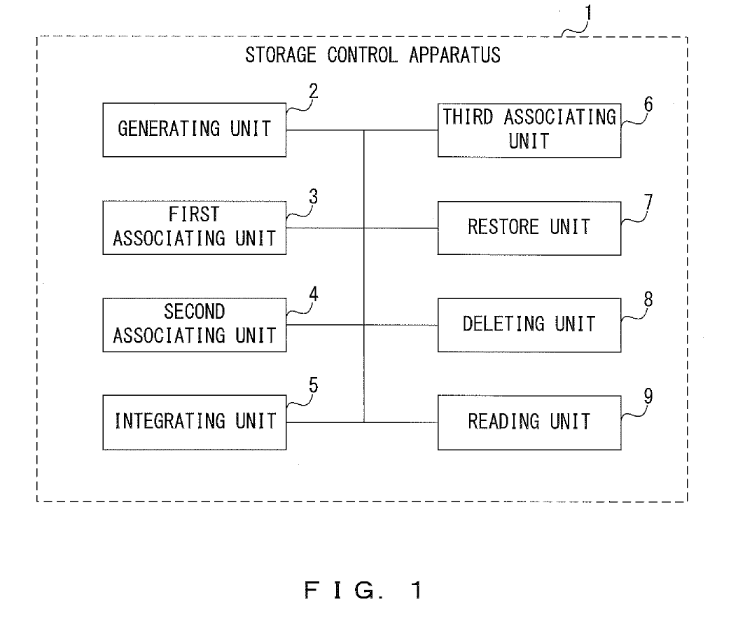

FIG. 1 illustrates an example of the configuration of a storage control apparatus according to an embodiment. In FIG. 1, a storage control apparatus 1 includes a generating unit 2, a first associating unit 3, a second associating unit 4, an integrating unit 5, a third associating unit 6, a restore unit 7, a deleting unit 8, and a reading unit 9.

The generating unit 2 generates, according to difference information that is difference information representing the difference between stationary points in a volume that represents the unit of management in the storage area and that is associated with a plurality of generations, aggregate information in which difference information for the plurality of generations is aggregated. The first associating unit 3 associates (ties) the aggregate information with the state of the volume at the oldest stationary point. The second associating unit 4 associates update information for the volume that has been updated from the state of the volume at the latest stationary point with the aggregate information.

Accordingly, the storage control apparatus 1 according to the embodiment may suppress the deterioration in the performance in the access to data of the generation in operation even when there are a large number of generations of snapshots.

When an obtaining instruction for obtaining a snapshot at a new stationary point is received, the integrating unit 5 merges the update information with the aggregate information. The third associating unit 6 associates the merged update information with difference information for the latest generation. The generating unit 2 further generates update information for the volume that has been updated from the state of the volume at the new stationary point. The second associating unit 4 associates the generated update information with the aggregate information.

Accordingly, in the storage control apparatus 1 according to the embodiment, even when the number of generations of snapshots increases, it becomes possible to obtain snapshots while maintaining the data structure with which the deterioration in the access performance may be suppressed.

When an obtaining instruction for obtaining a snapshot at a new stationary point is received, the generating unit 2 generates first update information that is update information for the volume that has been updated from the state of the volume at the new stationary point. Then, the generating unit 2 associates the first update information with second information that is update information that existed before the reception of the snapshot-obtaining instruction, and also sets the second update information as Read Only. The integrating unit 5 merges the second update information set as Read Only with the aggregate information. When the merge is completed, the second associating unit 4 cancels the association between the first update information and the second update information, and associates the first update information with the aggregate information. When the merge is completed, the third associating unit 6 cancels the association between the second update information and the aggregate information, and associates the second update information with the difference information of the latest generation.

Accordingly, in the storage control apparatus 1 according to the embodiment, it becomes possible to obtain snapshots without stopping the operation while preventing the deterioration in the access performance due to the increase in the number of generations.

When a restore instruction to a prescribed generation is received, the restore unit 7 first generates third update information that is update information for the volume that has been updated after receiving the restore instruction from the state of the volume of the restore-target generation. Next, the restore unit 7 associates the third update information with difference information for the restore-target generation, and also deletes the update information and the aggregate information before the reception of the restore instruction. Next, the restore unit 7 generates, according to all the difference information for the generation before the restore-target generation, aggregate information in which difference information is aggregated for all the generations before the restore-target generation. Then, the restore unit 7 associates the generated aggregate information with the state of the volume at the oldest stationary point, and associates the third update information with the generated aggregate information.

Accordingly, in the storage control apparatus 1 according to the embodiment, it becomes possible to perform a restore without stopping the operation while preventing the deterioration in the access performance due to the increase in the number of generations.

Difference information includes area information that indicates the storage area in which data before the change in the volume are stored, and includes data after the change in the storage area. The restore unit 7 extracts difference information in descending order of generations from the newer generation, from difference information for the generation before the restore-target generation. Then, the restore unit 7 stores, in the aggregate information, data after the change in the storage area for which the data after the change included in the generation that is newer than the extracted information do not exist in the aggregate information, among data after a change included in the extracted difference information.

Accordingly, in the storage control apparatus 1 according to the embodiment, the processing load required for the generation of aggregate information may be reduced.

When there are two pieces of difference information and an instruction for deleting difference information associated with the state of the volume at the oldest point is received, the deleting unit 8 deletes the two pieces of difference information. An obtaining instruction for obtaining a snapshot at a new stationary point is received while there is one piece of difference information and update information is associated with the difference information, and the generating unit 2 performs the following processes. That is, the generating unit 2 first generates first update information that is update information for the volume that has been updated from the state of the volume at the new stationary point. Then, the generating unit 2 associates the first update information with second information that is update information that existed before receiving the snapshot-obtaining instruction, and also sets the second update information as Read Only. Then, according to all the difference information for all the generations including the second update information, the generating unit generates aggregate information in which difference information for all the generations including the second update information is aggregated. After that, the second associating unit 4 cancels the association between the first update information and the second update information, and associates the first update information with the aggregate information.

Accordingly, the storage control apparatus 1 according to the embodiment makes it possible to suppress the storage capacity used in the management of snapshots. Then, the storage control apparatus 1 makes it possible to generate and delete snapshots while suppressing the storage capacity.

When a request for the reading of the current volume is received, the reading unit 9 reads data using the update information, the aggregate information and the state of the volume at the oldest stationary point. Meanwhile, a request for the reading of the volume at the latest stationary point is received, and the reading unit 9 reads data using the aggregate information and the state of the volume at the oldest stationary point.

Accordingly, the storage control apparatus 1 according to the embodiment makes it possible to improve the performance in reading the volume of the latest generation.

Hereinafter, snapshot data management according to the embodiment is explained in detail. First, snapshot data management methods according to two comparison examples are explained in order to explain the effect of the embodiment. After that, the snapshot data management according to the embodiment is explained, and the effects of the embodiment compared with the comparison examples are described.

### (Management Method According to the First Comparison Example)

The management method according to the first comparison example is a management method in which all the latest data of the volume in operation are stored in the base LUN, and difference information at the stationary point is stored in the COW.

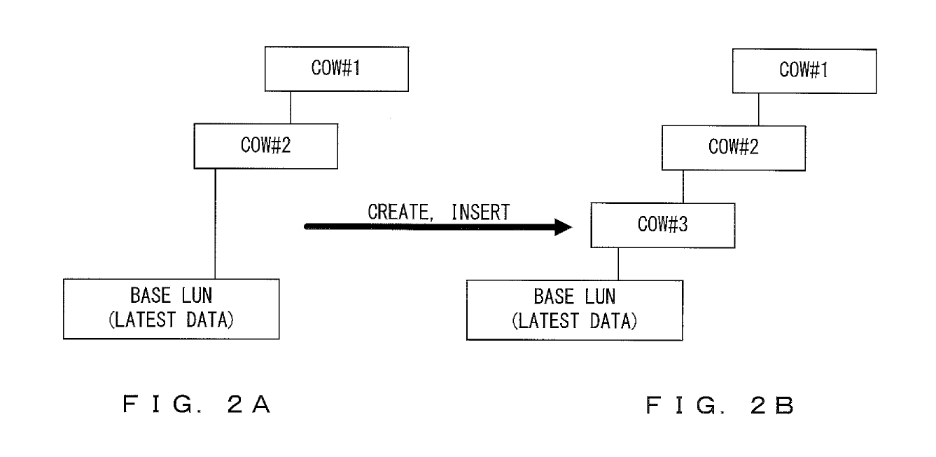

First, the generation of the COW in the first comparison example is explained. The generation of the COW is performed when obtaining a snapshot at a prescribed stationary point. FIGS. 2A-2B are explanatory diagrams for the generation of the COW in the first comparison example. FIGS. 2A-2B illustrate an example in which a COW#3 is created. FIG. 2A is a diagram illustrating the state of the snapshot management structure before the creation of the COW. FIG. 2B is a diagram illustrating the state of snapshots after the creation of the COW.

In FIG. 2A, COWs at two stationary points 1, 2 have already been obtained. COWs that corresponds to the stationary points 1, 2 are a COW#1 and a COW#2, respectively. Meanwhile, in the explanation below, it is assumed that a greater value of x for a stationary point x (x is a positive integer) indicates a later time for the stationary point. Meanwhile, a COW corresponding to a stationary point x is referred to as the COW#x.

In FIG. 2A, the base LUN, the COW#2, and the COW#1 are sequentially tied. The base LUN stores all the latest data of the volume in operation. The COW#2 tied to (associated with) the base LUN stores difference information between data at the stationary point 2 and the latest data. That is, the COW2 stores data that are data of the target volume at the stationary point 2 and that are different from the data stored in the base LUN. The COW#1 tied to the COW#2 stores difference information between data at the stationary point 1 and the data of the COW2. That is, the COW1 stores data that are data of the target volume at the stationary point 1 and that are different from the data at the stationary point 2.

A case in which the COW#3 corresponding to the stationary point 3 is created in FIG. 2A is considered. In this case, as illustrated in FIG. 2B, the newly created COW#3 is inserted between the COW of the newest generation (the COW#2 in the case of FIG. 2A) and the base LUN. That is, the new COW#3 is tied to the base LUN. Meanwhile, the tie for the COW#2 with the base LUN is cancelled, and the COW#2 is tied to the COW#3. The newly created COW#3 does not store any data immediately after the creation. The COW#3 is supposed to store data at the time of the writing process that is explained later. In addition, the COW2 is changed to a Read Only area. Meanwhile, the tie between the COW#1 and the COW#2 is not changed.

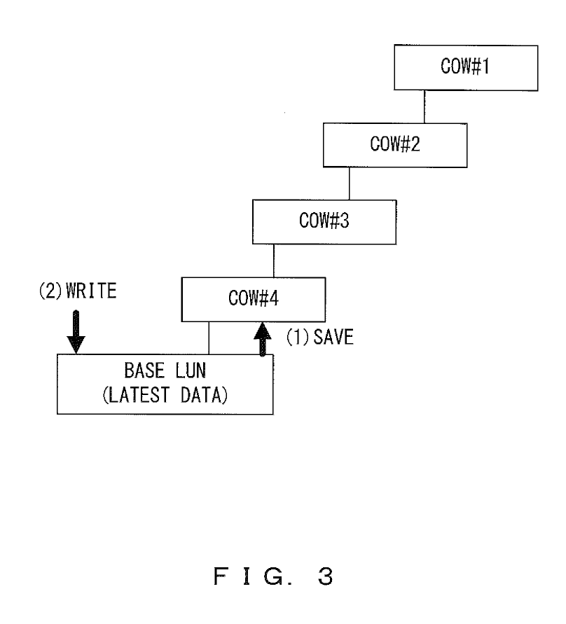

Next, the writing (WRITE) of data in the first comparison example is explained. FIG. 3 is an explanatory diagram for the writing of data in the first comparison example. In FIG. 3, when data are updated, first, data before a change stored in the area (chunk) that is the target of the change in the base LUN area are saved (stored) in the COW of the latest generation directly tied to the base LUN (COW#4 in the case of FIG. 3). Then, data after the change are stored in the change-target area in the base LUN. By doing so, it becomes possible to save the data in the volume in operation at each stationary point.

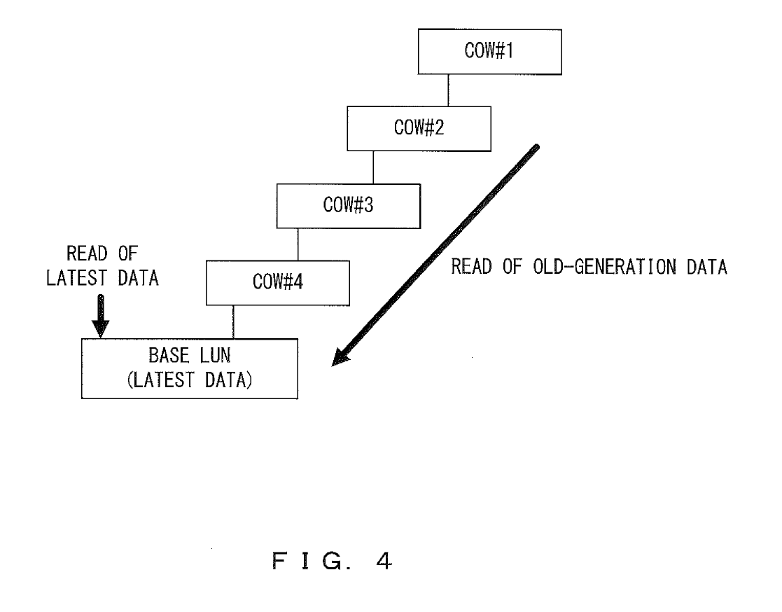

Next, the reading (READ) of data in the first comparison example is explained. FIG. 4 is an explanatory diagram for the reading of data in the first comparison example. In FIG. 4, when the latest data are read, the reading of data is performed directly from the base LUN. Meanwhile, when data at a stationary point of a prescribed generation are read, scanning is sequentially performed from the COW corresponding to the stationary point of the reference generation in the direction toward the newer generation, and the reading-target data are identified. Such scanning is to be performed until the reading-target data are confirmed to be stored in the scanned COWs or in the base LUN. Then, the reading of the identified reading-target data is performed.

In the first comparison example, even though the data-reading speed from the current volume in operation does not change, the reading speed with respect to the snapshot of an old generation tends to decrease. This is due to the following reason. That is, in the reading of data, scanning to see whether there is an update difference in the relevant area is performed from the COW corresponding to the reference generation in the direction toward the newer generation. For this reason, when there is no update from the reference generation up to the present, the COWs of all the generations from the reference generation to the present are to be scanned. Therefore, the reading speed with respect to an old generation decreases.

### (Management Method According to the Second Comparison Example)

The management method according to the second comparison example is a management method in which the oldest data are stored in the base LUN, and difference information at a stationary point is stored in the COW. In this management method, the COW holds data after a change with respect to data changed due to the update in the base LUN. In the first comparison example, the base LUN stores the latest data, whereas in the second comparison example, the oldest data are stored. In addition, in the first comparison example, the COW stores data before a change with respect to the target volume, whereas in the second example, data after a change are stored.

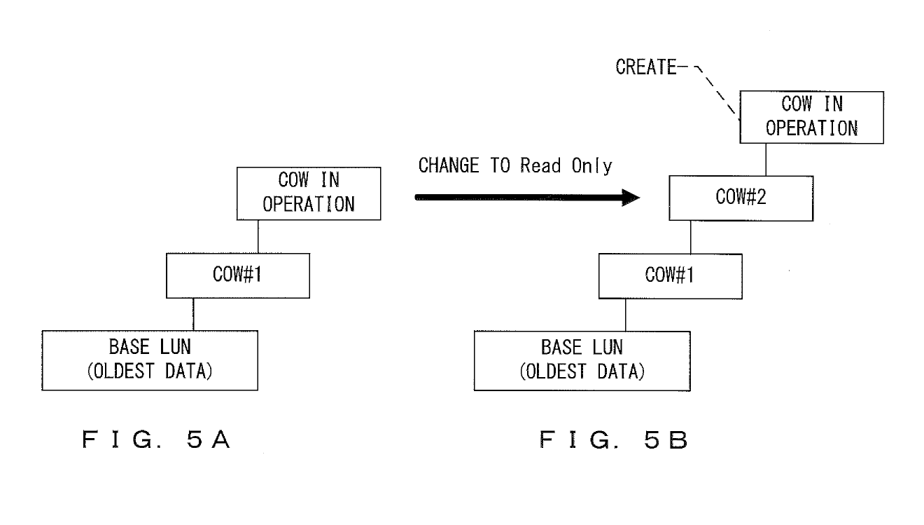

First, the generation of the COW in the second comparison example is explained. FIGS. 5A-5B are an explanatory diagrams for the generation of the COW in the second comparison example. FIGS. 5A-5B illustrate an example in which a COW#2 is created. FIG. 5A is a diagram illustrating the state of the snapshot management structure before the creation of the COW. FIG. 5B is a diagram illustrating the state of the snapshot management structure after the creation of the COW. In FIG. 5A, snapshots of two generations have already been obtained. That is, the COW#1 corresponding to the stationary point 1, and the COW in operation have been created.

In FIG. 5A, the base LUN, the COW#1, and the COW in operation are sequentially tied. The base LUN stores the oldest data. The COW#1 tied to the base LUN stores difference information between data of the target volume at the stationary point 1 and the oldest data. That is, the COW1 stores data that are data at the stationary point 1 and that are different from the data stored in the base LUN, and the COW in operation tied to the COW#1 stores difference information between the data of the target volume at the stationary point 1 and the latest data. That is, the COW in operation stores data that are the latest data and that are different from the data at the stationary point 1.

A case in which the COW#2 corresponding to the stationary point 2 is generated in FIG. 5A is considered. In this case, as illustrated in FIG. 5B, the COW in operation in FIG. 5A is set as the COW#2, and the newly created COW in operation is tied to the set COW#2. The COW in operation in FIG. 5A and the COW#2 in FIG. 5B are substantially the same, but the COW#2 is set as a Read Only area. Meanwhile, the newly created COW in operation is to store data that are the latest data and that are different from data at the stationary point 2. That is, the COW in operation stores data after a change with respect to the change applied to the target volume after the stationary point 2.

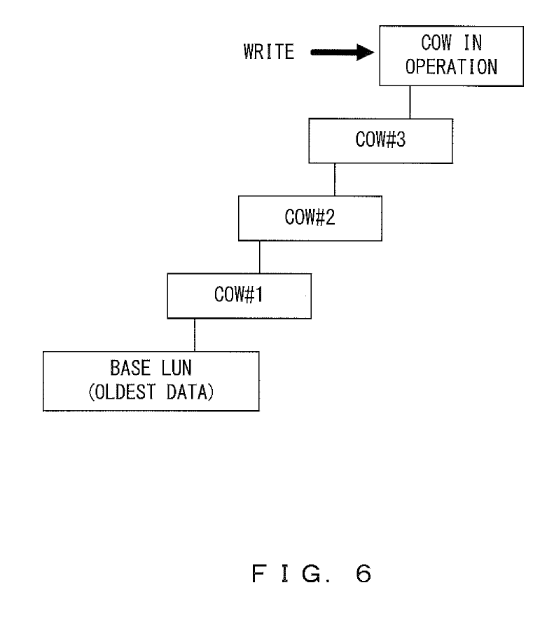

Next, the writing of data in the second comparison example is explained. FIG. 6 is an explanatory diagram for the writing of data in the second comparison example. In FIG. 6, when data are updated, data after a change with respect to the change-target data are written into the COW in operation. Data after the latest stationary point (the stationary point 3 in the case of FIG. 6) are written into the COW in operation, and the writing of data is not performed into the COW that corresponds to each stationary point, and therefore, the information of the target volume at each stationary point is maintained.

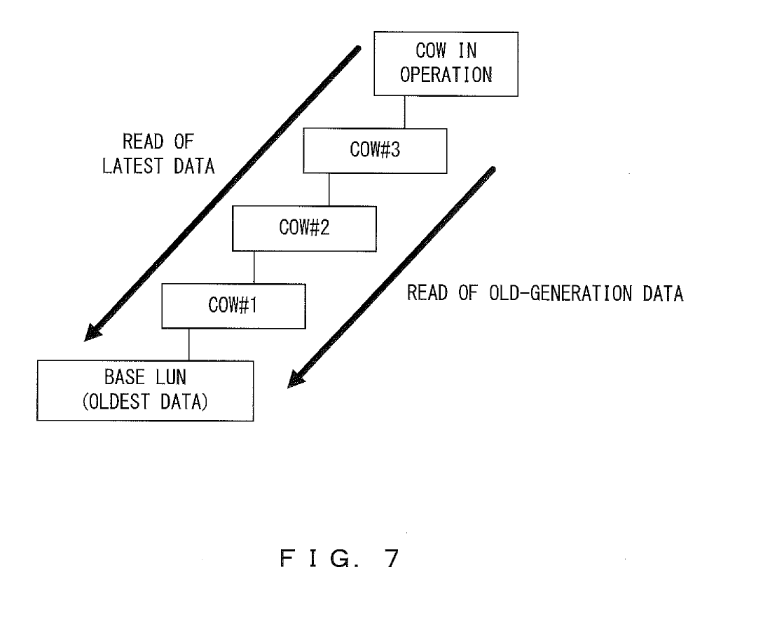

Next, the reading of data in the second comparison example is explained. FIG. 7 is an explanatory diagram for the reading of data in the second comparison example. In FIG. 7, when the latest data are read, scanning is sequentially performed from the COW in operation to the base LUN, and the reading-target data are identified. Then, the reading of the identified reading-target data is performed. When data at a stationary point of a prescribed generation are read, scanning is sequentially performed from the COW corresponding to the stationary point of the reference generation to the base LUN, and the reading-target data are identified. Then, the reading of the identified reading-target data is performed. In the second comparison example, each COW stores difference information after a change, and data with no change are not saved. Therefore, when an access is made to data with no change, the reading may be performed from the base LUN in some cases.

In the second comparison example, the reading speed with respect to the oldest generation does not change, but the reading speed with respect to a new generation tends to decrease. This is due to the following reason. That is, in the reading of data, scanning to see whether there is any update difference in the relevant area is performed from the COW corresponding to the reference generation in the direction toward the older generation. For this reason, when data of the reference generation have not been updated from the oldest data, all the COWs from the reference generation to the base LUN are to be scanned. Therefore, the reading speed with respect to a new generation decreases.

In the second comparison example, the writing performance with respect to the generation in operation is better than that in the first comparison example. This is because, in the first comparison example, when writing to the generation in operation occurs, a process for saving data of the update source to the COW occurs, as explained with reference to FIG. 3. On the other hand, in the second comparison example, the saving process for the update source data does not occur, and the process is completed with the writing into the COW in operation. For example, in the second comparison example, even when the whole writing into a chunk (the unit of data management for the COW) occurs, it is possible to skip the saving process for the update source data.

Meanwhile, compared with the second comparison example, the first comparison example involves more complicated processes in terms of the handling of old data and the rearrangement of the COWs when a snapshot is created.

However, in the second comparison example, the number of COWs to be scanned increases in line with the increase in the number of generations between the oldest generation and the reference generation, and therefore, the reading speed with respect to a newer generation tends to decrease. In the worst case, scanning to see whether there is a difference in the reading-target area is to be performed for the COWs of all the generations. This poses a large risk of deterioration in the performance in the generation in operation. That is, the reading performance is unstable, as it significantly changes depending on the reading-target area. Furthermore, considering that a snapshot is used for the purpose of backup, it is reasonably expectable that the number of generations is a large value. It is not desirable for the performance of the volume in operation to deteriorate due to the increase in the number of generations.

### Embodiment

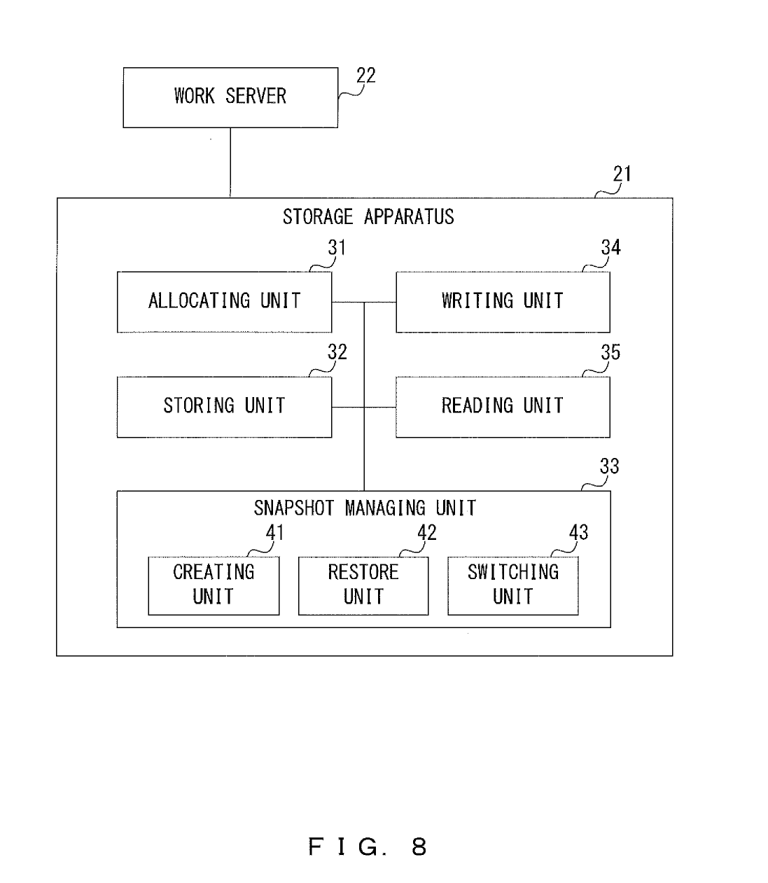

Next, the snapshot data management according to the embodiment is explained in detail. First, the configuration of a storage apparatus according to the embodiment is explained. FIG. 8 illustrates an example of the configuration of a storage apparatus according to an embodiment. In FIG. 8, a storage apparatus 21 connects to a work server 22 via a communication network or the like. The work server 22 is a server that gives instructions for reading and writing of data with respect to a target volume and for obtaining snapshots.

The storage apparatus 21 includes an allocating unit 31, a storing unit 32, a snapshot managing unit 33, a writing unit 34, and a reading unit 35.

The storage apparatus 21 is an example of the storage control apparatus 1. The snapshot managing unit 33 is an example of the generating unit 2, the first associating unit 3, the second associating unit 4, the integrating unit 5, the third associating unit 6, the restore unit 7, and the deleting unit 8. The reading unit 35 is an example of the reading unit 9.

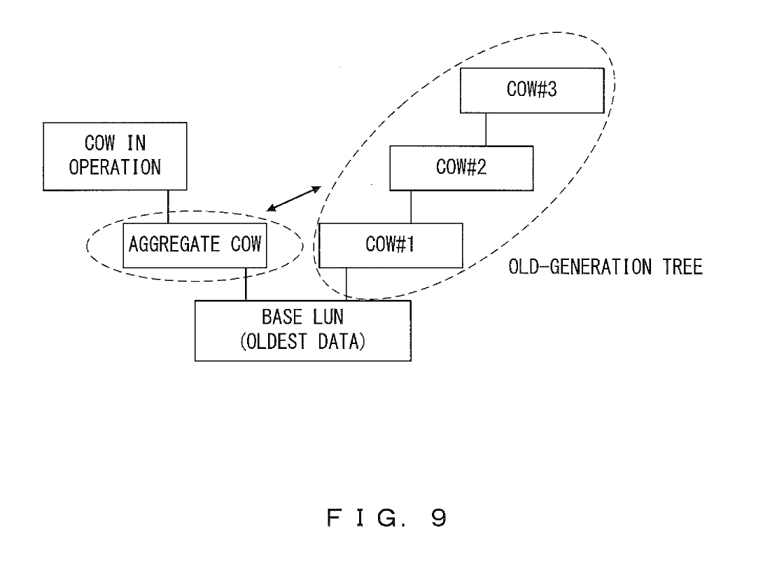

The allocating unit 31 offers the function of thin provisioning for allocating an actual physical area to a target volume (the base LUN), the COW or the like from a storage pool that is an aggregate of physical storage areas connected to the storage apparatus 21, along with the writing of data. The storing unit 32 includes the physical storage area allocated by the allocating unit 31, and stores respective data of the snapshot. Here, the respective data of the snapshot are data illustrated in FIG. 9 that is explained later. Meanwhile, the storing unit 32 may also be secured in an external storage area. The snapshot managing unit 33 manages the snapshot management structure. The snapshot managing unit 33 includes a creating unit 41, a restore unit 42, and a switching unit 43. Details of the respective units included in the snapshot managing unit 33 are explained later. The writing unit 34 performs the writing of data with respect to the volume in operation. The reading unit 35 performs the reading of data of the volume in operation or data of the target volume at a prescribed stationary point.

FIG. 9 illustrates an example of the snapshot management structure according to the embodiment. As illustrated in FIG. 9, in the embodiment, the base LUN, one or more COWs#x, the aggregate COW, and the COW in operation are tied and managed as follows. That is, the base LUN and COW#1 are tied, and the COW#x (x is a positive integer, x#1) and the COW#(x−1) are tied. Meanwhile, the base LUN and the aggregate COW are tied, and the aggregate COW and the COW in operation are tied. The base LUN, one or more COWs#x, the aggregate COW, and the COW in operation are respectively stored in the storing unit 32 allocated by the allocating unit 31.

The base LUN is an example of the state of the volume at the oldest stationary point. The COWs#x are examples of difference information. The aggregate COW is an example of the aggregate information. The COW in operation is an example of update information.

In the explanation below, for the sake of convenience of explanation, the snapshot management structure according to the embodiment is explained as a tree structure. That is, in the snapshot management structure, the base LUN, each of one or more COWs#x, the aggregate COW, and the COW in operation are assumed as a node, and tied nodes are linked by a link. The base LUN is the root node. The parent node of the COW#1 is the base LUN. The parent node of the COW#x (x#1) is the COW#(x−1). The parent node of the aggregate COW is the base LUN. The parent node of the COW in operation is the aggregate COW. Meanwhile, when referring particularly to the COW of the latest generation among the COW#x, the description COW#X is used, and the stationary point corresponding to the COW#X is referred to as the stationary point X. Meanwhile, the generation for which difference information is being obtained in the COW in operation may be referred to as the generation in operation.

The base LUN stores the oldest data. The COW#1 tied to the base LUN stores difference information between data of the target volume at the stationary point 1 and the oldest data. That is, COW1 stores the data of the target volume at the stationary point 1 that are different from data stored in the base LUN. The COW#x (x#1) stores difference information data of the target volume at the stationary point x and data at the stationary point x−1. The aggregate COW stores data in which the previously created COW#X through COW#1 are aggregated. That is, the aggregate COW stores difference information between the data of the target volume at the stationary point and the oldest data. In other words, the aggregate COW stores the data at the stationary point X that are different from the data in the base LUN. The COW in operation stores difference information between the data of the target volume at the stationary point x and the latest data. In the explanation below, the COW#1 through the COW#X are collectively referred to as an old-generation tree. In addition, when the COW#x, the aggregate COW, and the COW in operation are not to be particularly distinguished, they are simply referred to as the COW.

Meanwhile, while the respective COWs are stored in the storing unit, the storage areas in which the respective COWs are stored do not need to be continuous areas, and each COW may be stored in a different storage area in a different storing apparatus.

Now, the snapshot management structure according to the embodiment is compared with the second comparison example. In the embodiment, compared with the second comparison example, the aggregate COW in which all the COWs of the old-generation tree are aggregated into one is added. In addition, in the second comparison example, the COW in operation is tied to the old-generation tree. On the other hand, in the embodiment, the COW in operation is tied to the aggregate COW. That is, the management structure according to the embodiment is in a configuration in which the old-generation tree in the second comparison example and the newly added aggregate COW are used together.

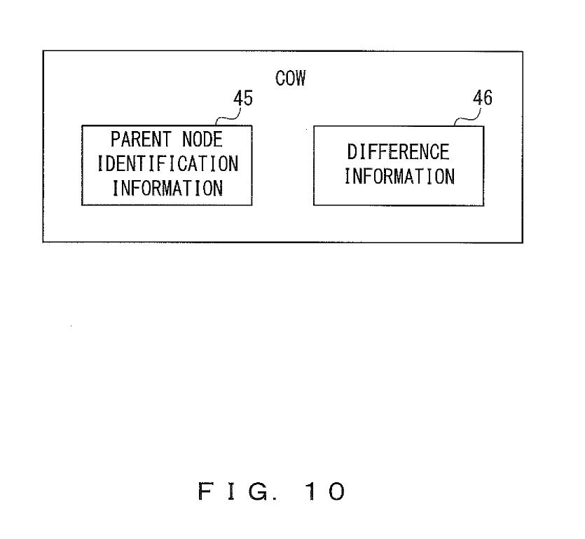

FIG. 10 illustrates an example of the data structure of COWs (COWs#x, the aggregate COW, and the COW in operation). Each COW may be recognized as one device (storage device) by the Operating System (OS) of the storage apparatus 21. In addition, for each COW, the capacity of the COW recognized by the OS and the physical storage capacity that is actually allocated may be controlled by the thin provisioning function of the allocating unit 31. The COW includes parent node identification information 45 and difference information 46.

The parent node identification information 45 is identification information for the parent node. Specifically, in the case of the COW#1 for example, identification information for the base LUN is stored in the parent node identification information 45. In the case of the COW#x (x#1), identification information for the COW#(x−1) is stored in the parent node identification information 45. In the case of the aggregate COW, identification information for the base LUN is stored in the parent node identification information 45. In the case of the COW in operation, identification information for the aggregate COW is stored in the parent node identification information 45. Meanwhile, in the case of a system in which the node is handled as one device the parent node identification information 45 may be a combination of the major number and the minor number of the parent node. Meanwhile, the parent node identification information 45 may also be a pointer or the like to the storage area in which data of the COW of the parent node are stored.

The difference information 46 is difference information for the target volume at the stationary point of the local node with respect to the target volume at the stationary point of the parent node. Specifically, in the case of the COW#1 for example, the difference information 46 is difference information for the target volume at the stationary point 1 with respect to the base LUN. In the case of the COW#x (x#1), the difference information 46 is difference information for the target volume at the stationary point x with respect to the COW#(x−1). In the case of the aggregate COW, the difference information 46 is difference information for the target volume at the stationary point X with respect to the base LUN. In the case of the COW in operation, the difference information 46 is difference information for the current target volume with respect to the aggregate COW.

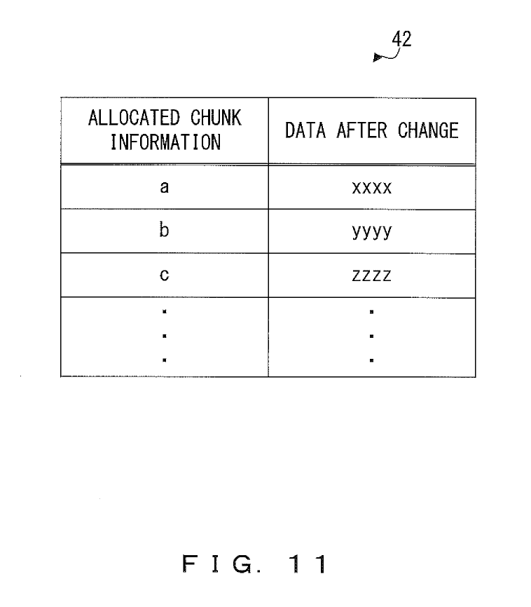

FIG. 11 illustrates an example of the configuration of the difference information 46. The difference information 46 includes data items “Allocated chunk information” and “Data after change”, and the respective data items are associated and stored for each record. “Allocated chunk information” is identification information that indicates the chunk (block) of data that have been changed from the stationary point of the parent node. “Allocated chunk information” is expressed by the offset position from the start address of the volume of the chunk (block), the address of the chunk (block) or the like, for example. “Data after change” are data of the chunk indicated by the corresponding “Allocated chunk information” after a change. In the explanation below, The chunk stored in the difference information 46 may be referred to as an allocated chunk.

Meanwhile, data after a change do not have to be directly stored in “Data after change”, and for example, data after a change may be stored in another storage area, and information indicating the address of such another storage area that stores the data after a change may be stored in “Data after change”.

The size of the difference information 46 increases as changes are added to the data of the volume. The allocating unit 31 increases the size of the physical area allocated to the COW, by the thin provisioning function, along with the increase in the size of the difference information 46.

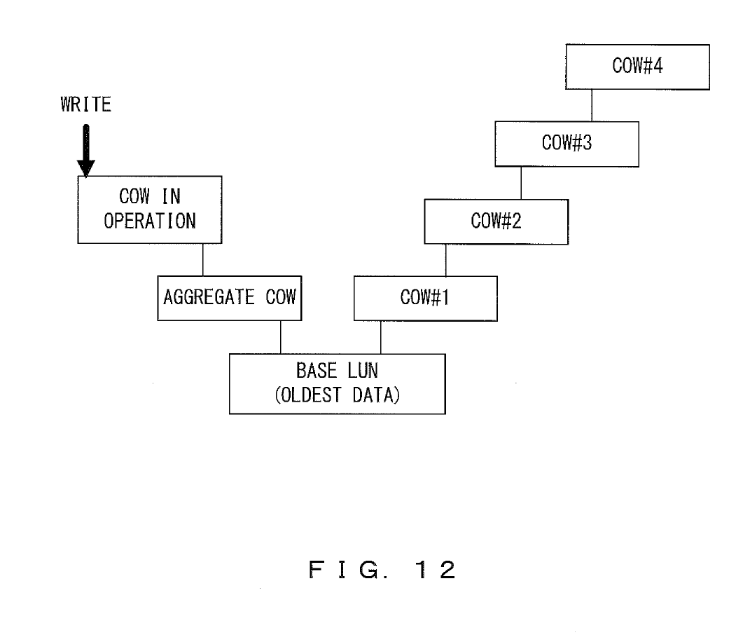

Next, the writing of data in the embodiment is explained. FIG. 12 is an explanatory diagram for the writing of data in the embodiment. In FIG. 12, when data of a target volume are updated, the writing unit 34 writes data of the change-target data after a change into the COW in operation. The writing of data is executed to the COW in operation, and no accesses occur to other COWs.

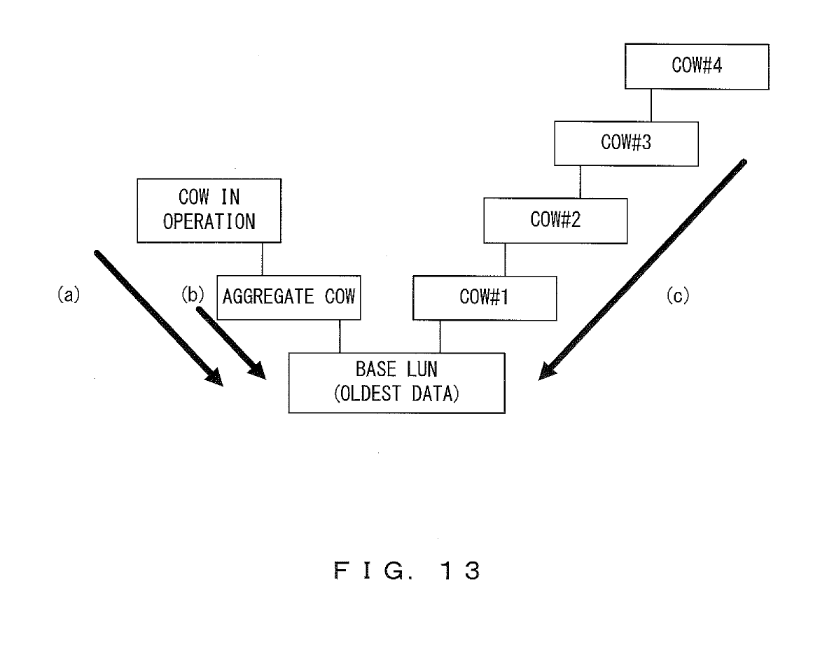

Next, the reading of data in the embodiment is explained. FIG. 13 is an explanatory diagram for the reading of data in the embodiment. The reading of data in the embodiment is divided into three patterns. The three patterns of reading are, specifically, the reading of data of the generation in operation, the reading of data of the generation immediately before the generation in operation, and the reading of data of the generation that is older than the generation in operation by two generations or more.

In the reading of data of the generation in operation, the reading unit 35 sequentially performs scanning from the COW in operation to the base LUN (FIG. 13 (a)), and identifies the reading-target data. Then, the reading unit 35 performs the reading of the reading-target data. Here, only the aggregate COW exists between the COW in operation and the base LUN, and therefore, the reading process is completed with two COW operations at most, even in the worst case. Accordingly, the performance in the reading process may be made faster and stable.

In the reading of data of the generation immediately before the generation in operation, the reading unit 35 sequentially performs scanning from the aggregate COW to the base LUN (FIG. 13 (b)), and identifies the reading-target data. Then, the reading unit 35 performs the reading of the reading-target data. Here, in the reading of data of the generation immediately before the generation in operation, the reading process is completed with one COW operation at most, even in the worst case. Accordingly, the performance in the reading process may be made faster and stable.

In the reading of data of the generation that is older than the generation in operation by two generations or more, the reading unit 35 sequentially performs scanning from the COW corresponding to the stationary point of the reference generation to the base LUN (FIG. 13(c)), and identifies the reading-target data. Then, the reading unit 35 performs the reading of the reading-target data.

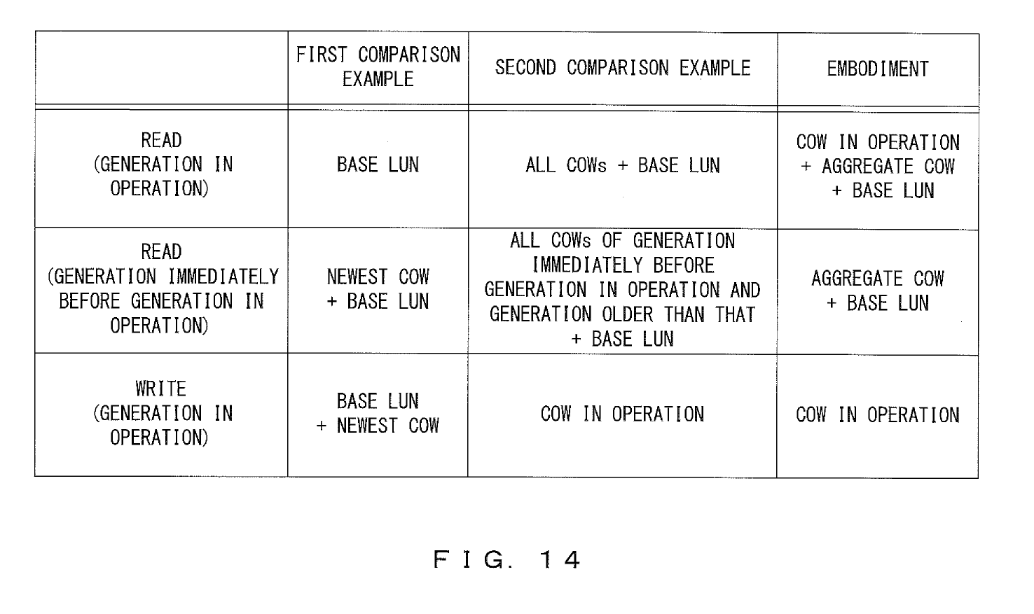

Here, the comparison examples and the embodiment are compared in terms of the performances in reading and writing. FIG. 14 is a comparison diagram for the reading and writing performances in the comparison examples and the embodiment. In FIG. 14, the worst values of the numbers of the COWs and the base LUN scanned in the reading or writing process are compared. In the reading or writing process, the smaller the numbers of the COWs and the base LUN scanned in the reading or writing process, the better the processing performance.

First, the performance in the reading for the generation in operation are compared. As illustrated in FIG. 14, the scanning target in the first comparison example is the base LUN. Meanwhile, the scanning targets in the second comparison example are all the COW and the base LUN. The scanning targets in the embodiment are the COW in operation, the aggregate COW, and the base LUN. According to these, in terms of the performance in the reading for the generation in operation, the embodiment is inferior to the first comparison example. Meanwhile, the performance of the embodiment in the reading for the generation in operation is superior to that of the second comparison example when there are three or more generations for which the snapshot is to be obtained.

Next, a comparison is made of reading of data of the generation immediately before the generation in operation. As illustrated in FIG. 14, the scanning targets in the first comparison example are the COW of the latest generation and the base LUN. Meanwhile, the scanning targets in the second comparison example are the COW of the generation immediately before the generation in operation and generations older than that, and the base LUN. The scanning targets in the embodiment are the aggregate COW and the base LUN. According to these, in terms of the performance in the reading of data of the generation immediately before the generation in operation, the embodiment is on par with the first comparison. Meanwhile, the reading performance of the embodiment is superior to that of the second comparison example when there are three or more generations for which the snapshot is to be obtained.

Next, a comparison is made about the writing of data. As illustrated in FIG. 14, the access targets in the first comparison example are the base LUN and the COW of the latest generation. Meanwhile, the access target in the second comparison example is the COW in operation. The access target in the embodiment is the COW in operation. Accordingly, in terms of the performance in the reading of the generation in operation, the embodiment is superior to the first comparison example. Meanwhile, the writing performance of the embodiment is equivalent to that of the second comparison example.

In the embodiment, the COWs of the old-generation tree are not referred to in the reading of the generation in operation and the reading of the generation immediately before the generation in operation. Therefore, for example, in the case in which the frequency of reading of the generations included in the old-generation tree is low, a part or the entirety of the COWs included in the old-generation tree may be secured in an area of a low-speed storage medium such as a tape or the like or a storing apparatus. This enables a flexible disk management. Meanwhile, in the second comparison example, there is a possibility that all the COWs will be scanned in the reading of the generation in operation and the reading of the generation immediately before the generation in operation. Therefore, in the second comparison example, when the configuration in which a part or the entirety of the COWs included in the old-generation tree are secured in an area of a low-speed storage medium such as a tape or the like or when a storing apparatus is adopted, the reading of the generation in operation and the reading of the generation immediately before the generation in operation also become slow.

Next, the management of the snapshot management structure in the embodiment is explained. The management of the snapshot management structure is performed by the snapshot managing unit 33. As illustrated in FIG. 8, the snapshot managing unit 33 includes the creating unit 41, the restore unit 42, and the switching unit 43.

The creating unit 41 creates a new COW corresponding to a prescribed stationary point. The restore unit 42 executes the restore of the snapshot. The switching unit 43 switches the management form of the snapshot management structure according to the number of generations of the obtained COW. Hereinafter, the operation of each unit of the snapshot managing unit 33 is explained in this order.

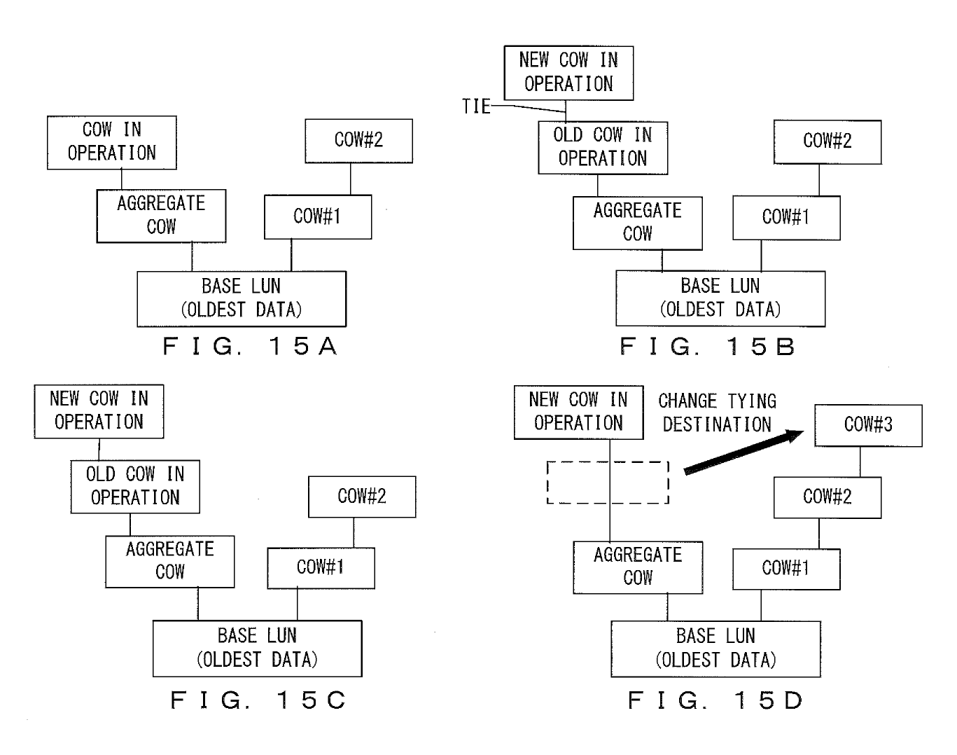

Details of the creation of the COW by the creating unit 41 are explained. The creation process for the COW according to the embodiment may be executed without stopping the operation of the target volume, from the viewpoint of the work server 22. FIGS. 15A-15D are explanatory diagrams for the creation of the COW according to the embodiment.

FIG. 15A presents the state of the snapshot management structure before the creation of the COW. In FIG. 15A, two COWs, namely a COW#1 and a COW#2 have already been created. When the creating unit 41 receives an instruction from the work server 22 for obtaining a snapshot, the creating unit 41 starts the creation process for the COW. When the creation process for the COW is started, the state first shifts to the state in FIG. 15B.

In FIG. 15B, the creating unit 41 creates a new COW in operation, and ties the new COW in operation to the old COW in operation (the COW in operation in FIG. 15A). No data are stored in the new COW in operation when it is created, and therefore, the creating unit 41 is able to create the new COW in operation in an instant. After this, the writing of data from the work server 22 is performed to the new COW in operation. When the tying is completed, the state shifts to the state in FIG. 15C.

In FIG. 15C, the creating unit 41 first sets the access from the work server 22 to the old COW in operation as Read Only. Then, the creating unit 41 merges the content of the old COW in operation with the aggregate COW. The old COW in operation has been set as Read Only, and therefore, no conflict occurs between the access from the work server 22 and the access from the merge process. Therefore, the merge process may be executed on the background. Meanwhile, the Read Only setting may be made by the creating unit 41 as an attribute of the COW itself for example, or it may be realized by controlling the writing unit 34 so as to not access the old COW in operation at the time of the writing process. When the merge is completed, the state shifts to the state in FIG. 15D.

In FIG. 15D, a changing process for the ties for the old COW in operation is performed. Specifically, the creating unit 41 first cancels the tie between the old COW in operation and the aggregate COW, and the tie between the old COW in operation and the new COW in operation. Then, the creating unit 41 ties, as the COW#3, the old COW in operation to the COW#2. Meanwhile, the difference information 46 of the COW#3 and the old COW in operation is the same. Accordingly, the content of the old COW in operation is stored as difference information for the target volume at the stationary point. In addition, the creating unit 41 ties the new COW in operation to the aggregate COW. By such a control, the content of the aggregate COW becomes a content in which the COW#1 through the COW#3 included in the old-generation tree are merged.

Meanwhile, in FIG. 15D, in a strict sense, the creating unit 41 stops I/O with the target volume from the work server 22 during the changing process for the ties. However, the changing process for the ties may be completed in a very short time. For this reason, the work server 22 does not recognize that the operation of the target volume stopped.

By creating the new COW in operation and tying it to the old COW in operation, the access from the work server 22 to the old COW in operation and the aggregate COW may be set as Read Only, and the merge may be executed on the background. In addition, the new COW in operation may be created in an instant, and the new COW in operation becomes the destination of the writing of data from the work server 22. For this reason, the snapshot may be obtained without stopping the operation, making it possible to prevent conflict between the data writing process from the work server 22 and the merge process into the aggregate COW.

As for the data reading process, it does not conflict with the merge process for the following reason. That is, when data are read from the same logic address as that of the merge-destination chunk, the reading of data is not done from the aggregate COW, but from the old COW in operation. Therefore, even during the merge process into the aggregate COW, no reading occurs from the merge-destination chunk.

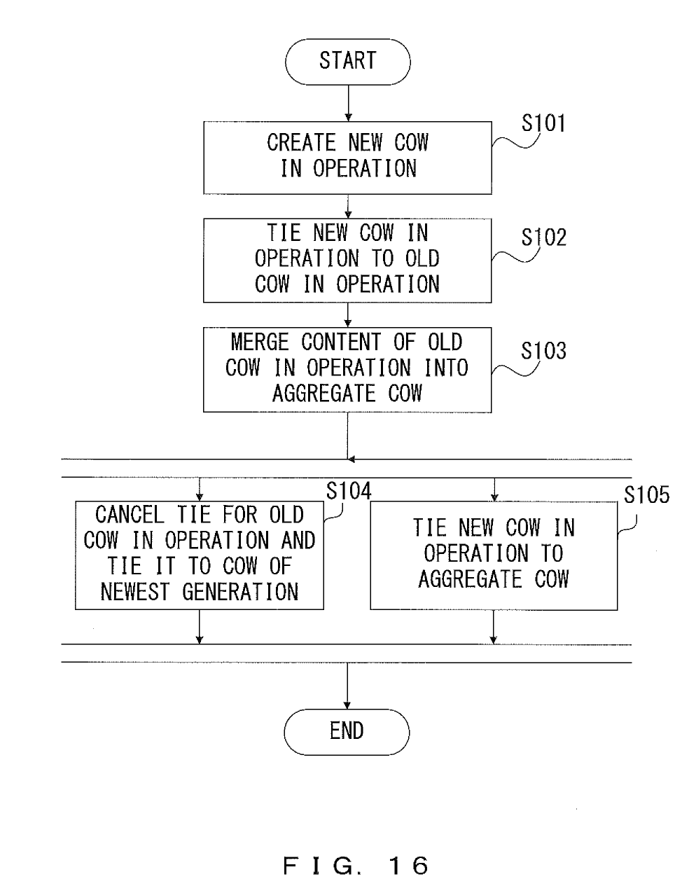

FIG. 16 is an example of a flowchart that illustrates details of the COW creation process. The flow in FIG. 16 starts when an instruction for a snapshot is received from the work server 22.

In FIG. 16, the creating unit 41 first creates a new COW in operation (S101). No data are stored in the new COW in operation when it is created, and therefore, the creating unit 41 is able to create the new COW in operation in an instant.

Next, the creating unit 41 ties the new COW in operation to the old COW in operation (S102). That is, the creating unit 41 stores identification information of the old COW in operation in the parent node identification information 45 of the new COW in operation. Together with this tying, the creating unit 41 sets the access from the work server 22 to the old COW in operation as Read Only. After this, the writing of data to the target volume is performed to the new COW in operation.

Next, the creating unit 41 merges the content of the old COW in operation with the aggregate COW (S103). That is, the creating unit 41 adds the content of the difference information 46 of the old COW in operation to the difference information 46 of the aggregate COW.

Next, the creating unit 41 executes the contents of S104 and S105 in parallel. In S104, the creating unit 41 cancels the tie between the old COW in operation and the aggregate COW, and the tie between the old COW in operation and the new COW in operation. Specifically, the creating unit 41 deletes identification information of the aggregate COW stored in the parent node identification information 45 of the old COW in operation. In addition, the creating unit 41 deletes identification information of the old COW stored in the parent node identification information 45 of the new COW in operation. Then, the creating unit 41 ties the old COW in operation to the COW#X of the newest generation. Specifically, the creating unit 41 stores identification information of the COW#X in the parent node identification information 45 of the old COW in operation. In the example in FIGS. 15A-15D, the COW#X of the newest generation is COW#2.

In parallel to S104, in S105, the creating unit 41 ties the new COW in operation to the aggregate COW. Specifically, the creating unit 41 stores identification information of the aggregate COW in the parent node identification information 45 of the new COW in operation.

When the processes in S104 and S105 are completed, the COW creation process is terminated.

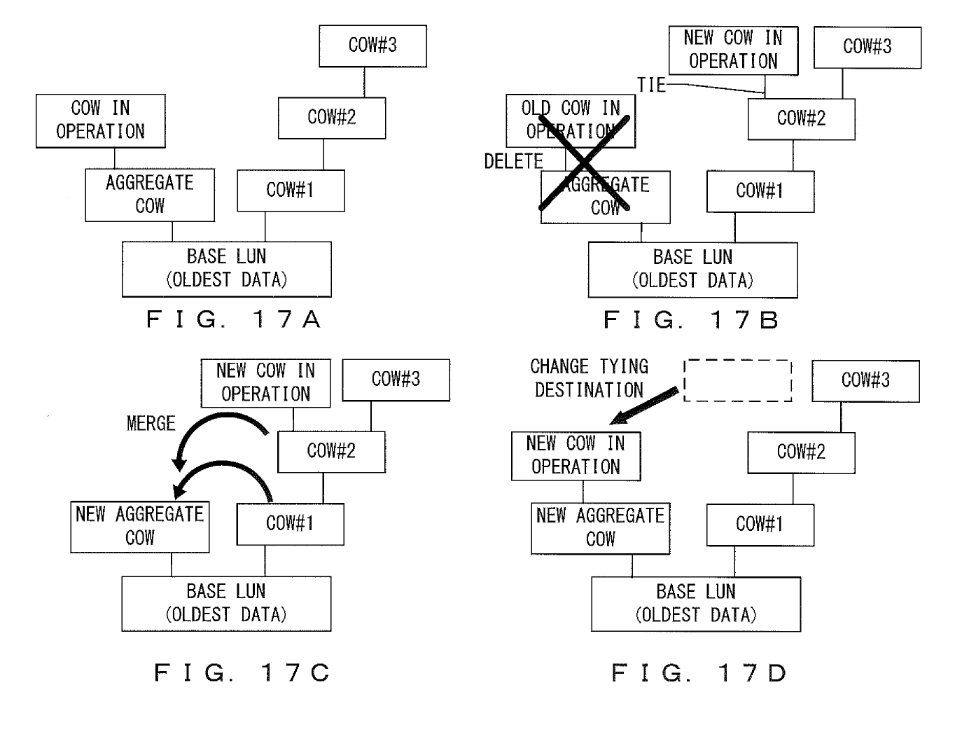

Next, details of the restore process performed by the restore unit 42 are explained. A restore is a process for replacing the content of the generation in operation with the content of a snapshot obtained in the past. The restore of the snapshot according to the embodiment may be executed without stopping the operation of the target volume from the viewpoint of the work server 22. FIGS. 17A-17D are explanatory diagrams for a restore according to the embodiment.

FIG. 17A illustrates the state of the snapshot management structure before a restore. In FIG. 17A, three COWs, namely COW#1, COW#2, COW#3 have already been created. When an instruction is received from the work server 22 for a restore to the COW#2, the restore unit 42 starts the restore process. When the restore process is started, the state first shifts to the state in FIG. 17B.

In FIG. 17B, the restore unit 42 creates a new COW in operation, and ties the created new COW in operation to the COW#2 that is the restore-target generation. After this, the writing of data from the work server 22 is performed to the new COW in operation. Next, the restore unit 42 deletes the old COW in operation and the old aggregate COW. When the deletion is completed, the state shifts to the state in FIG. 17C.

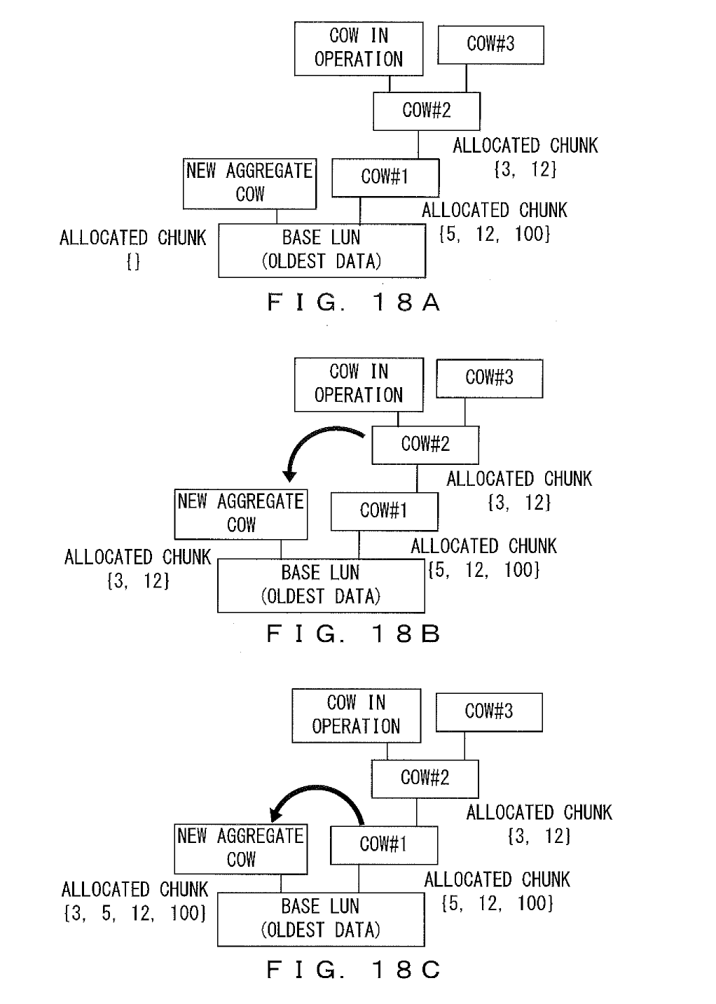

In FIG. 17C, the restore unit 42 first creates a new aggregate COW, and ties the created new aggregate COW to the base LUN. Then, the restore unit 42 merges the contents of the COWs of the generations older than the restore-target generation sequentially one by one into the new aggregate COW. Details of this merge are explained later with reference to FIGS. 18A-18C. When the merge is completed, the state shifts to the state in FIG. 17D.

In FIG. 17D, the restore unit 42 performs a changing process for the ties with the new COW in operation. That is, the restore unit 42 cancels the tie between the new COW in operation and the COW of the restore-target generation, and ties the new COW in operation to the new aggregate COW. The restore process is completed in this manner.

Meanwhile, in FIG. 17D, in a strict sense, the restore unit 42 stops I/O with respect to the target volume from the work server 22 during the changing process for the ties of the new COW in operation. However, the changing process for the ties may be completed in a very short time. For this reason, the work server 22 does not recognize that the operation of the target volume stopped. Therefore, in the restore process, a restore may be performed without stopping the operation, by creating a new COW in operation and tying it to the COW of the restore-target generation.

The merge process at the time of a restore in FIG. 17C is explained in detail. The merge at the time of a restore is executed from the COW of the newer generation in order to reduce the data quantity in the merge process. Therefore, the chunk already merged by the merge for the COW of a newer generation is excluded from the target of the merge for the COW of an older generation. FIGS. 18A-18C are explanatory diagrams for the merge process in a restore according to the embodiment. In FIGS. 18A-18C, the explanation is made assuming the COW#2 as the COW of the restore-target generation.

FIG. 18A illustrates the state of the snapshot management structure immediately before the merge process in FIG. 17C. In FIG. 18A, {3, 12} are stored as the allocated chunks for the COW#2. Meanwhile, {5, 12, 100} are stored as the allocated chunks for the COW#1. No allocated chunks are stored in the new aggregate COW immediately after the creation. When the merge process is started, the state first shifts to the state in FIG. 18B.

In FIG. 18B, the restore unit 42 starts the merge process into the new aggregate COW from the COW of the restore-target generation. In the example in FIG. 18B, the COW of the restore-target generation is the COW#2. That is, the restore unit 42 merges {3, 12} that are the allocated chunks for the COW#2 into the new aggregate COW. Specifically, the restore unit 42 adds the record whose “Allocated chunk information” is {3, 12} in the difference information 46 in the COW of the restore-target generation into the difference information 46 of the new aggregate COW. As a result, {3, 12} are stored in the new aggregate COW as allocated chunks. When the merge for the COW#2 is completed, the state shifts to the state in FIG. 18C.

In FIG. 18C, the restore unit 42 selects the COW of the newest generation and for which the merge has not been executed among the COWs of generations older than the COW of the restore-target generation. The COW selected here is the COW#1 in the example in FIG. 18C. Then, the restore unit 42 merges the content of the selected COW into the new aggregate COW. Here, among the allocated chunks of the selected COW, the chunk that has already been merged is excluded from the target of the merge. That is, among the allocated chunks {5, 12, 100} for the COW#1, the restore unit 42 excludes the chunk {12} for which the merge has been executed in #COW2 from the target for the merge. Therefore, the restore unit 42 merges the allocated chunks {5, 100} for the COW#1 other than the chunk excluded from the target of the merge into the new aggregate COW. Specifically, the restore unit 42 adds the record whose “Allocated chunk information” is {5, 100} in the difference information 46 of the COW#1 to the difference information 46 of the new aggregate COW. As a result, {3, 5, 12, 100} are stored in the new aggregate COW as allocated chunks.

As described above, the restore unit 42 may reduce the quantity of data to be merged by executing merging sequentially from the COW of the newer generation and excluding the chunk that has already been merged from the target of the merge.

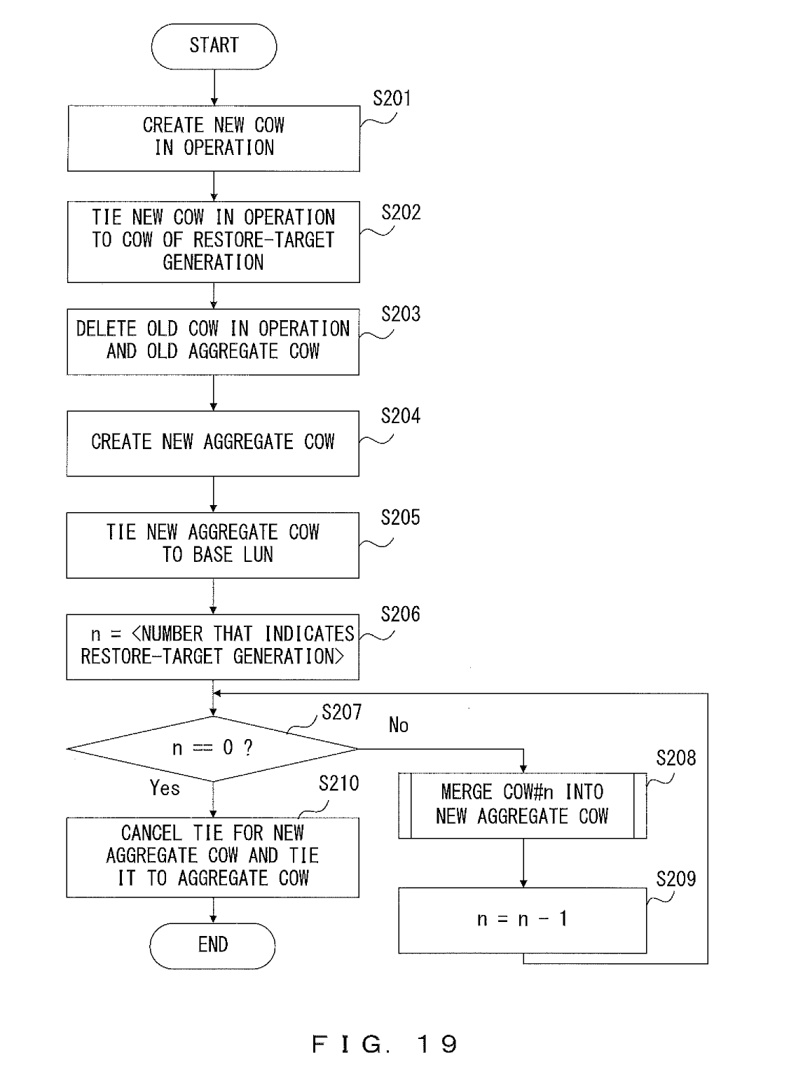

FIG. 19 is an example of a flowchart illustrating details of the restore process. The flow in FIG. 19 starts when an instruction is received from the work server 22 for restore to a prescribed generation, for example.

In FIG. 19, the restore unit 42 first creates a new COW in operation (S201). No information is stored in the new COW in operation when it is created, and therefore, the restore unit 42 is able to create the new COW in operation in an instant.

Next, the restore unit 42 ties the new COW in operation to the COW of the restore-target generation (S202). That is, the creating unit 41 stores identification information of the COW of the restore-target generation in the parent node identification information 45 of the new COW in operation.

Next, the restore unit 42 deletes the old COW in operation, and the old aggregate COW (S203).

Next, the restore unit 42 creates a new aggregate COW (S204).

Next, the restore unit 42 ties the new aggregate COW to the base LUN (S205). Specifically, the restore unit 42 stores identification information of the base LUN in the parent node identification information 45 of the new aggregate COW.

Next, the restore unit 42 substitutes a value that represents the number that indicates the generation of the COW of the restore-target generation into a variable n (S206). In the example in FIGS. 17A-17D, the number of the generation of the restore-target generation is “2”, and therefore, “2” is substituted into n.

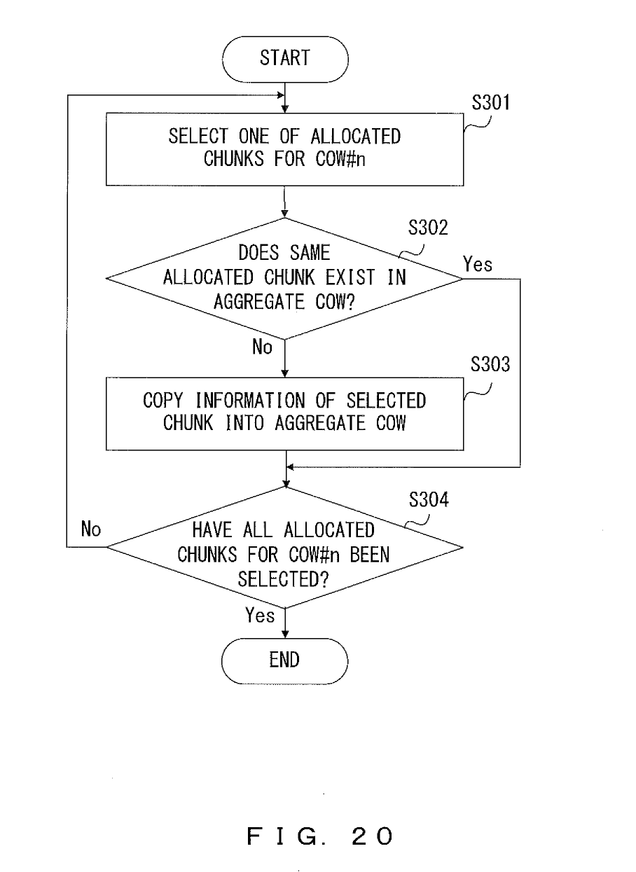

Next, the restore unit 42 determines whether or not the variable n is “0” (S207). When the restore unit 42 determines that the variable n is not “0” (S207, No), the restore unit 42 merges the content of the COW whose generation corresponds to the variable n, that is, the content of the COW#n into the new aggregate COW (S208). Details of the merge process into the new aggregate COW are described later using FIG. 20.

Next, the restore unit 42 decrements the value of the variable n (S209). Then, the process shifts again to S207.

When the restore unit 42 determines that the variable n is “0” in S207 (S207, Yes), the restore unit 42 cancels the current tie with the new COW in operation, and ties the new COW in operation to the new aggregate COW (S210). Specifically, the restore unit 42 first deletes identification information of the COW of the restore-target generation stored in the parent node identification information 45 of the new COW in operation. Then, the restore unit 42 stores identification information of the new aggregate COW in the parent node identification information 45 of the new COW in operation.

Then, when the tying of the new COW in operation and the new aggregate COW is completed, the restore process is terminated.

FIG. 20 is an example of a flowchart illustrating details of the merge process in the restore process. This merge process represents details of the process executed in S208 in FIG. 19. FIG. 20 illustrates the process for merging the content of the COW#n into the new aggregate COW.

In FIG. 20, the restore unit 42 first selects one allocated chunk among the allocated chunks for COW#n (S301). Specifically, for example, the restore unit 42 selects one record of the difference information 46 of the COW#n.

Next, the restore unit 42 determines whether or not the same chunk as the allocated chunk selected in S301 already exists in the new aggregate COW (S302). Specifically, for example, the restore unit 42 determines whether or not a record whose “Allocated chunk information” matches the “Allocated chunk information” of the record selected in S301 exists among records included in the difference information 46 of the new aggregate COW. When it is determined that the same chunk as the selected allocated chunk already exists in the new aggregate COW (S302, Yes), the process shifts to S304.

On the other hand, when the restore unit 42 determines that the same chunk as the selected allocated chunk does not exist in the new aggregate COW (S302, No), the restore unit 42 copies the information of the selected chunk to the aggregate COW (S303). Specifically, for example, the restore unit 42 adds the record selected in S301 to the difference information 46 of the new aggregate COW.

Next, the restore unit 42 determines whether or not all the allocated chunks for the COW#n have already been selected in S301 (S304). When there is any chunk that has not been selected among the allocated chunks for the COW#n (S304, No), the process shifts again to S301. Then, in S301, the restore unit 42 selects one of the allocated chunks that has not been selected among the allocated chunks for the COW#n, and repeats the processes after S302.

On the other hand, when it is determined that all the allocated chunk for the COW#n have been selected (S304, Yes), the merge process is terminated.

Next, switching of the snapshot management structure is explained.

The switching unit 43 switches the management form of the snapshot management structure according to the generation of the obtained snapshot. Specifically, the switching unit 43 performs switching between the management form illustrated in FIG. 9 (hereinafter, referred to as the management form 1) and the management form according to the second comparison example (hereinafter, referred to as the management form 2). As explained using FIG. 14, the performance of the management form 1 according to the embodiment is better than that of the management form 2 according to the second comparison example when snapshots of three generations or more are obtained. When snapshots of two generations or less are obtained, the improvement in performance is not expected, and an extra storage capacity is consumed due to the aggregate COW. Therefore, the switching unit 43 performs the switching of the management form to the management form 2 when snapshots of two generations or less are obtained, and to the management form 1 when snapshots of three or more generations are obtained. Accordingly, the storage capacity to be used may be suppressed while maintaining the optimal snapshot management structure.

The switching process from the management form 2 to the management form 1 and the switching process from the management form 1 to the management form 2 are explained in this order.

First, the switching from the management form 2 to the management form 1 is explained. This switching is executed when the snapshot of the third generation is obtained in the state in which the snapshot of the second generation has already been obtained.

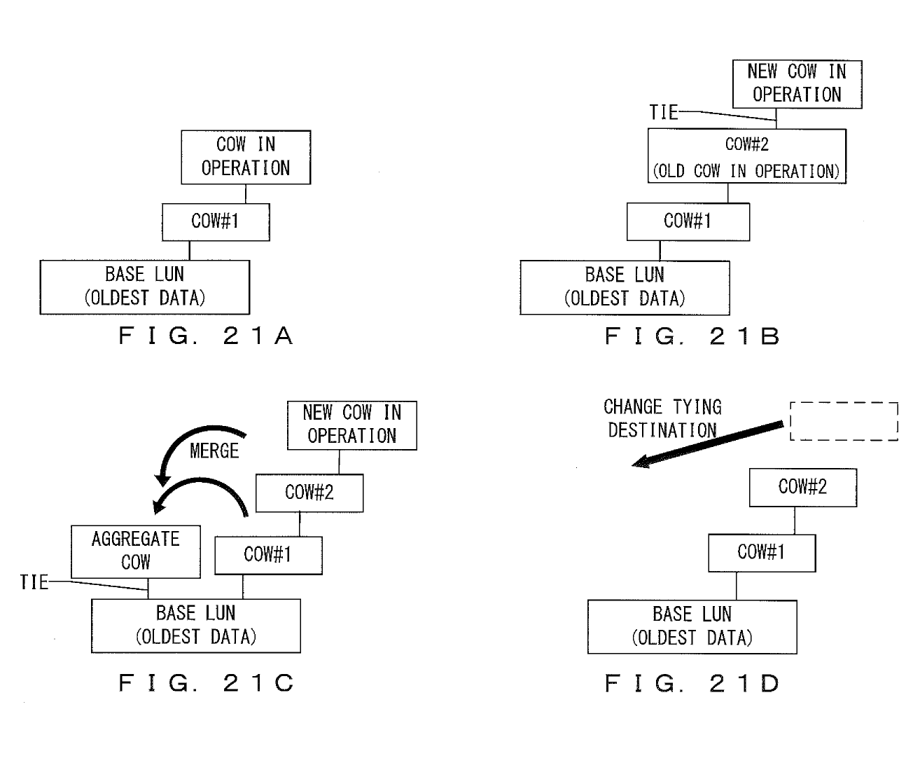

FIGS. 21A-21D are explanatory diagrams for the switching process from the management form 2 to the management form 1 according to the embodiment. The process for the switching of the management form 2 to the management form 1 is partly realized by the process that is similar to the restore explained with reference to FIGS. 17A-17D.

FIG. 21A presents the state of the snapshot management structure before switching. In FIG. 21A, snapshots for two generations have already been obtained. That is, two COWs, namely the COW#1 and the COW in operation have been created. At this time, when an instruction is received from the work server 22 for obtaining a snapshot, the switching unit 43 starts the switching process. When the switching process is started, the state first shifts to the state in FIG. 21B.

In FIG. 21B, the switching unit 43 creates a new COW in operation, and ties the created new COW in operation to the old COW in operation. Together with the tying, the switching unit 43 sets the old COW in operation as the COW#2, and sets the access from the work server 22 as Read Only. After this, the writing of data from the work server 22 is performed to the new COW in operation. The COW#2 is set as Read Only, and therefore, the following processes may be performed on the background. Next, the state shifts to the state in FIG. 21C.

In FIG. 21C, the switching unit 43 first creates the aggregate COW, and ties the created aggregate COW to the base LUN. Then, the switching unit 43 merges the contents of the COW#2 and the COW#1 into the aggregate COW sequentially one by one. Details of this merge are the same as those explained with reference to FIGS. 18A-18C and FIG. 20. When the merge is completed, the state shifts to the state in FIG. 21D.

In FIG. 21D, the switching unit 43 performs a changing process for the ties with the new COW in operation. That is, the switching unit 43 cancels the tie between the new COW in operation and the COW#2, and ties the new COW in operation to the aggregate COW. The switching process from the management form 2 to the management form 1 is completed in this manner.

Meanwhile, in FIG. 21D, in a strict sense, the switching unit 43 stops I/O with respect to the target volume from the work server 22 during the changing process for the ties with the new COW in operation. However, the changing process for the ties may be completed in a very short time. For this reason, the work server 22 does not recognize that the operation of the target volume stopped. Therefore, in the switching process from the management form 2 to the management form 1, the switching may be performed without stopping the operation by creating a new COW in operation and tying it to the COW#2.

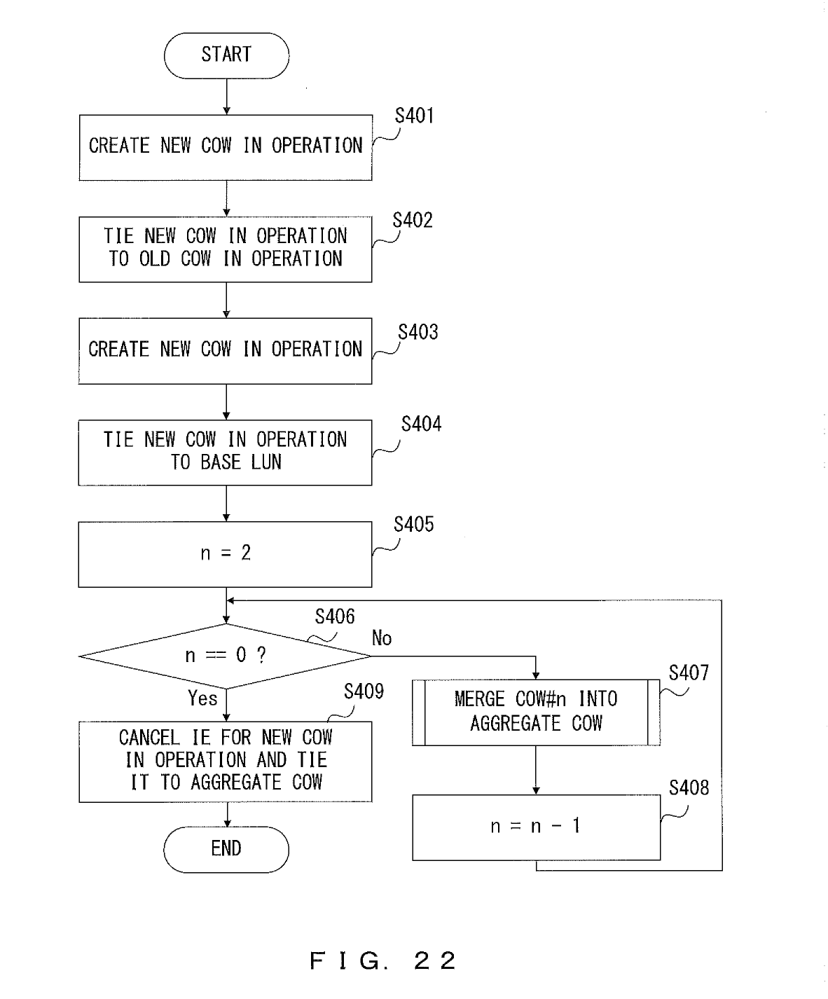

FIG. 22 is an example of a flowchart illustrating details of the switching process from the management form 2 to the management form 1. The flow in FIG. 22 starts when an instruction is received from the worker server 22 for obtaining a snapshot, for example in the state in which two COWS, namely the COW#1 and the COW in operation, have already been obtained as illustrated in FIG. 21A.

In FIG. 22, the switching unit 43 first creates a new COW in operation (S401). No information is stored in the new COW in operation immediately after creation, and therefore, the switching unit 43 is able to create the new COW in operation in an instant.

Next, the switching unit 43 ties the new COW in operation to the old COW in operation (S402). That is, the creating unit 41 stores identification information of the old COW in operation in the parent node identification information 45 of the new COW in operation. Together with this tying, the switching unit 43 sets the access from the work server 22 to the old COW in operation as Read Only, and sets the old COW in operation as the COW#2.

Next, the switching unit 43 creates a new aggregate COW (S403).

Next, the switching unit 43 ties the new aggregate COW to the base LUN (S404). Specifically, the switching unit 43 stores identification information of the base LUN in the parent node identification information 45 of the new aggregate COW.

Next, the switching unit 43 substitutes “2” into the variable n (S405).

Next, the switching unit 43 determines whether or not the variable n is “0” (S406). When the switching unit 43 determines that the variable n is not “0” (S406, No), the switching unit 43 merges the content of the COW whose generation corresponds to the variable n, that is, the content of the COW#n, into the new aggregate COW (S407). Details of the merge process into the new aggregate COW are the same as those explained using FIG. 20.

Next, the switching unit 43 decrements the value of the variable n (S408). Then, the process shifts again to S406.

In S406, when the switching unit 43 determines that the variable n is “0” (S406, Yes), the switching unit 43 cancels the current tie with the new COW in operation, and ties the new COW in operation to the new aggregate COW (S409). Specifically, first, the switching unit 43 deletes identification information of the old COW in operation (COW#2) stored in the parent node identification information 45 of the new COW in operation. Then, the switching unit 43 stores identification information of the new aggregate COW in the parent node identification information 45 of the new COW in operation.

Then, when the tying between the new COW in operation and the new aggregate COW is completed, the switching process from the management form 2 to the management form 1 is completed.

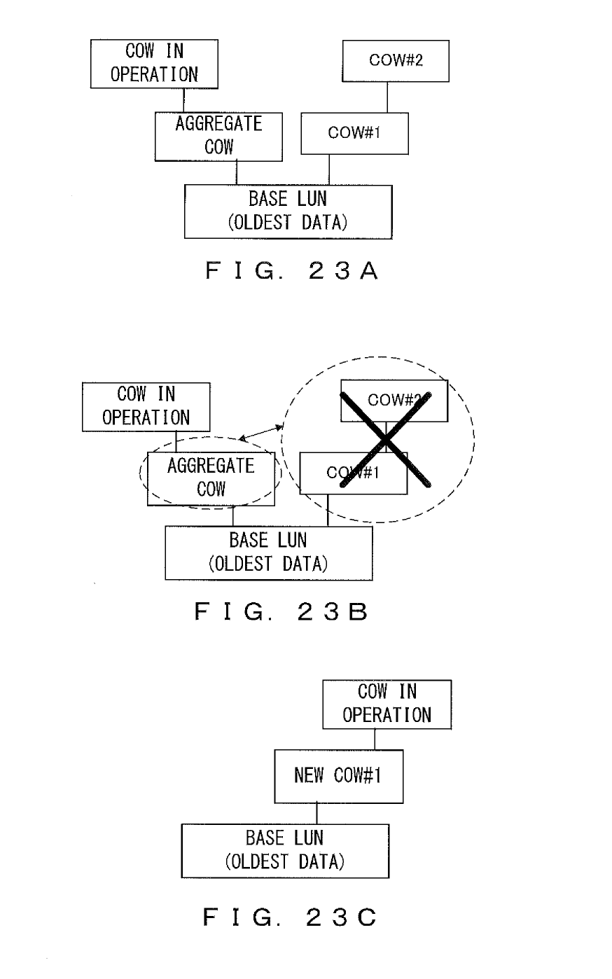

Next, the switching from the management form 1 to the management form 2 is explained. This switching is executed when, from the state in which snapshots of three generations have been obtained, the number of generations of snapshots decreases to two generations as a result of deletion of the generation in the middle. FIGS. 23A-23C are explanatory diagrams for the switching process from the management form 1 to the management form 2. FIGS. 23A-23C present an example in which the number of generations of snapshots decreases to two generations by deletion of the COW#1.

FIG. 23A presents the state of the snapshot management structure before switching. In FIG. 23A, snapshots of three generations have already been obtained. That is, the COW#1, the COW#2, and the aggregate COW have been created. When an instruction for deleting the COW#1 is received from the work server 22, the switching unit 43 starts the switching process. When the switching process is started, the state first shifts to the state in FIG. 23B.

In FIG. 23B, the switching unit 43 deletes the COW#1 and the COW#2. When the deletion is completed, the state shifts to the state in FIG. 23C.

In FIG. 23C, the switching unit 43 treats the aggregate COW as the new COW#1. The switching process from the management form 2 to the management form 1 is completed in this manner.

The state of the COW in operation does not change in the switching process from the management form 1 to the management form 2, therefore, the switching may be made without stopping the operation.

Meanwhile, when the generation immediately before the COW in operation, that is, the COW#2, is to be deleted, it is impossible to perform switching from the management form 1 to the management form 2. This is due to the following reason. That is, when the COW of the generation in the middle is deleted, the difference information 46 possessed by the deleted COW is lost unless the difference information 46 possessed by the deleted COW is merged into the child node. In the management form 2, the child node of the COW#2 is the COW in operation. Therefore, when the COW#2 is to be deleted, I/O would occur due to the merge into the COW in operation. This causes a conflict between I/O due to the merge and I/O from the work server 22. Therefore, in the embodiment, when the COW#2 is to be deleted, the switching unit 43 continues the operation in the management form 1 without performing the switching from the management form 1 to the management form 2 in order to prevent the occurrence of such a conflict.

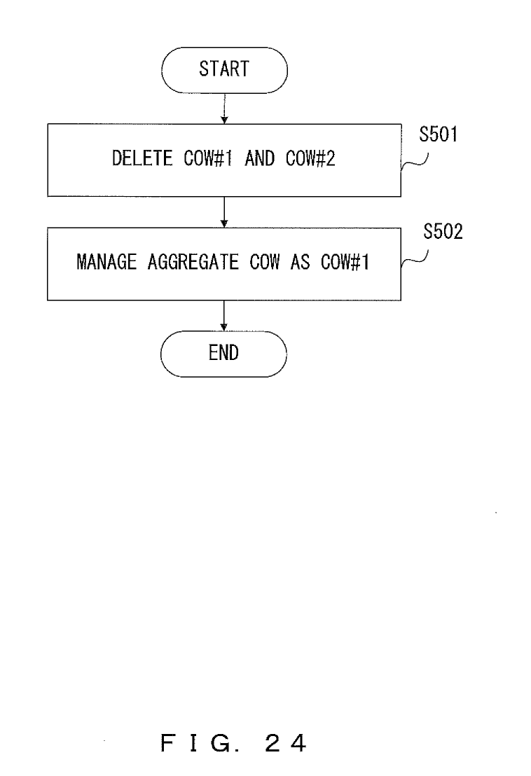

FIG. 24 is an example of a flowchart illustrating details of the switching process from the management form 1 to the management form 2. The flow in FIG. 24 starts when an instruction for deleting the COW#1 from the work server 22 is received, for example, in the state in which the COW#1, COW#2, the aggregate COW, and the COW in operation have already been created as illustrated in FIG. 23A.

In FIG. 24, the switching unit 43 first deletes the COW#1 and the COW#2 (S501). Next, the switching unit 43 manages the aggregate COW as the COW#1 (S502). Then, the switching process from the management form 1 to the management form 2 is terminated.

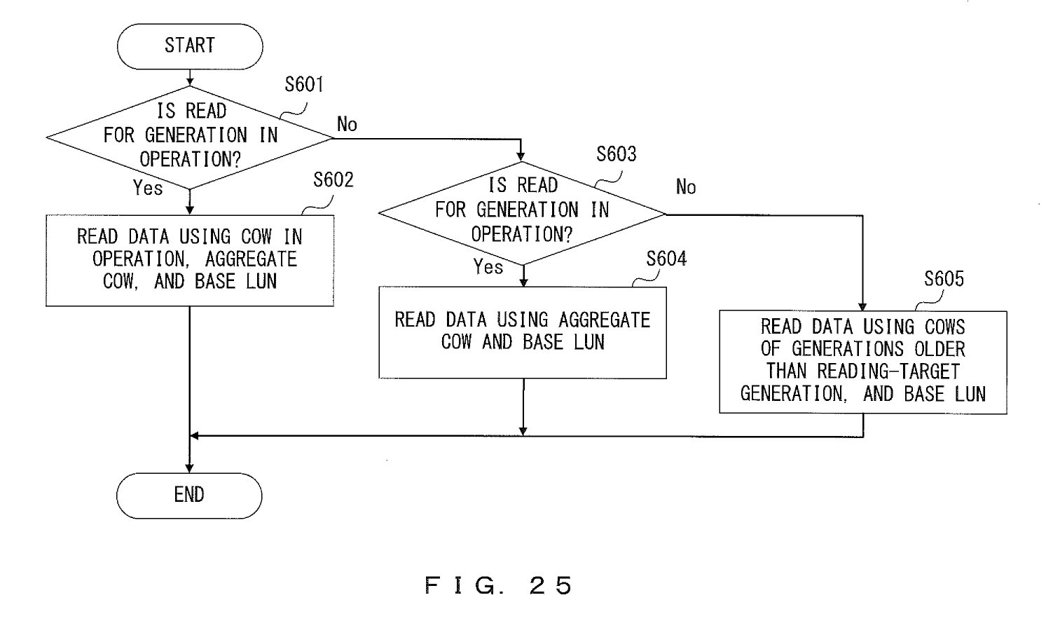

Next, the flow of the reading process according to the embodiment is explained. FIG. 25 is an example of a flowchart illustrating details of the reading process according to the embodiment. The flow in FIG. 25 starts when an instruction is received from the work server 22 for reading data from the target volume of a prescribed generation, for example.

In FIG. 25, when a reading request is received from work server 22, the reading unit 35 first determines whether or not the reading-target generation is the generation in operation (S601). When the reading unit 35 determines that the reading-target generation is the generation in operation (S601, Yes), the reading unit 35 performs the reading of data using the COW in operation, the aggregate COW, and the base LUN (S602). That is, the reading unit 35 performs scanning from the COW in operation to the aggregate COW to the base LUN in this order, and identifies the reading-target data. Meanwhile, the reading unit 35 performs the sequential scanning by identifying the parent node according to the parent node identification information 45 of each COW. Then, the reading unit 35 performs the reading of the reading-target data. Then, the reading process is terminated.

When the reading unit 35 determines in S601 that the reading-target generation is not the generation in operation (S601, No), the reading unit 35 determines whether or not the reading-target generation is the generation immediately before the generation in operation (the latest generation of the obtained still points) (S603). When the reading unit 35 determines that the reading-target generation is the generation immediately before the generation in operation (S603, Yes), the reading unit 35 performs the reading of the data using the aggregate COW and the base LUN (S604). That is, the reading unit 35 performs scanning of the aggregate COW and the base LUN in this order, and identifies the reading-target data. Meanwhile, the reading unit identifies the base LUN according to the parent node identification information 45 of the aggregate COW. Then, the reading unit 35 performs the reading of the reading-target data. Then, the reading process is terminated.

When the reading unit 35 determines in S603 that the reading-target generation is not the generation immediately before the generation in operation (S603, No), the reading unit 35 performs the reading of data using the COWs older than the generation of the reading-target generation and the base LUN (S605). That is, assuming the stationary point of the reading-target generation as the stationary point n, the reading unit 35 performs the reading of data using the COW#n, the COW# (n−1) through the COW#1 that is older than the reading-target generation, and the base LUN (S605). Specifically, the reading unit 35 performs scanning sequentially from the child node to the parent node according to the identification information 45, from the COW#n of the reading-target generation to the base LUN, and identifies the reading-target data. Then, the reading unit 35 performs the reading of the reading-target data. Then, the reading process is terminated.

Next, an example of the hardware configuration of the storage apparatus 21 according to the embodiment is explained. FIG. 25 illustrates an example of the hardware configuration of the storage apparatus 21 according to the embodiment.

The storage apparatus 21 includes one or more controller modules (hereinafter, referred to as CM) 51 (51a, 51b), and one or more storing apparatuses 52 (52a through 52d). Meanwhile, the storage apparatus 21 is connected to the work server 22 via a communication network, for example.

The CM 51 performs various controls in the storage system, and controls the access to the storing apparatuses 52 according to commands received from the work server 22. Meanwhile, while the number of CMs is 2 in the example in FIG. 25, the number of CMs is not limited to 2.

The CM 51 includes a Central Processing Unit (CPU) 61 (61a, 61b), the memory 62 (62a, 62b), a reading apparatus 63 (63a, 63b), and a communication interface 64 (64a, 64b). The CPU 61, the memory 62, the reading apparatus 63, and the communication interface 64 are connected via a bus or the like.

The CPU 61 provides a part or the entirety of the functions of the allocating unit 31, the snapshot managing unit 33, the writing unit 34, and the reading unit 35 by executing a program in which the procedures of the flowcharts described above are described, using the memory 62.

The memory 62 is a semiconductor memory for example, which is configured including a Random Access Memory (RAM) area and a Read Only Memory (ROM) area. The memory 62 may also be a semiconductor memory such as a flash memory or the like.

The reading apparatus 63 accesses a removable storage medium 80 (80a, 80b) according to instructions from the CPU 61. The removable storage medium 80 is realized by a semiconductor device (a USB memory or the like), a medium to/from which information is input/output by magnetic action (a magnetic disk or the like), a medium to/from which information is input/output by optical action (a CD-ROM, a DVD, or the like), and so on, for example. Meanwhile, the reading apparatus 63 does not have to be included in the storage apparatus 21.

The communication interface 64 communicates with the storing apparatus 52 or the work server 22 via a bus, an interconnect or a network or the like, according to instructions from the CPU 61. The communication interface that performs communication with the storing apparatus 52 is, specifically, a Serial Attached SCSI (SAS) interface, for example.

The program according to the embodiment is provided to the storage apparatus 21 in the following forms, for example.

(1) Installed in storing apparatus 52 in advance.

(2) Provided by the removable storage medium 80.

(3) Provided from a program server (not illustrated in the drawing) via the communication interface 64.

The storing apparatus 52 is a hard disk, for example. In addition, the storing apparatus 52 may also be a semiconductor memory such as a flash memory or the like. In addition, the storing apparatus 52 may also be an external recording apparatus. The storing apparatus 52 provides a part or all of the functions of the storing unit 32.

The storage apparatus 21 may have a configuration in which a plurality of storage apparatuses 21 are connected via an interconnect. In this case, one or more storing apparatuses 52 of the respective storage apparatuses 21 may be combined to constitute one storage pool.

In addition, the storage apparatus 21 may also be an information processing apparatus in which the CPU 61, the memory 62, the reading apparatus 63 (may be omitted), the communication interface 64, and the storing apparatus 52 are included in one chassis.

Furthermore, a part of the storage apparatus 21 according to the embodiment may be realized by hardware. Alternatively, the storage apparatus 21 according to the embodiment may also be realized by a combination of software and hardware.

Meanwhile, the present embodiment is not limited to the form of the embodiment described above, and various configurations or embodiments may be adopted without departing from the gist of the present embodiment.

All examples and conditional language provided herein are intended for the pedagogical purpose of aiding the reader in understanding the invention and the concepts contributed by the inventor to further the art, and are not to be construed as limitations to such specifically recited examples and conditions, nor does the organization of such examples in the specification related to a showing of the superiority and inferiority of the invention. Although one or more embodiments of the present invention have been described in detail, it should be understood that the various changes, substitutions, and alterations could be made hereto without departing from the spirit and scope of the invention.

1. A storage control apparatus comprising:
a processor configured
to generate, according to difference information that represents a difference between stationary points in a volume that represents a management unit for a storage area and that is associated with a plurality of generations, aggregate information in which the difference information for the plurality of generations is aggregated,
to associate the aggregate information with a state of the volume at an oldest stationary point, and
to associate update information for a volume that has been updated from a state of the volume at a latest stationary point.

2. The storage control apparatus according to the claim 1, wherein
the processor configured to merge the update information into the aggregate information when an obtaining instruction for obtaining a snapshot at a new stationary point is received,
to associate, with the difference information of a latest generation, the update information that has already been merged, to generate update information of a volume that has been updated from a state of the volume at the new stationary point, and
to associate the generated update information with the aggregate information.

3. The storage control apparatus according to claim 2, wherein
when an obtaining instruction for obtaining a snapshot at a new stationary point is received, the processor generates first update information that is update information for a volume that has been updated from a state of the volume at the new stationary point and associates the first update information with second update information that is the update information that existed before receiving the obtaining instruction, and also sets the second information as read-only, performs merging of the second update information set as read-only into the aggregate information,
when the merging is completed, the processor cancels association between the first update information and the second update information, and associates the first update information with the aggregate information, and
when the merging is completed, the processor cancels association between the second update information and the aggregate information, and associates the second update information with difference information for the latest generation.

4. The storage control apparatus according to claim 1, wherein
the processor configured to receive a restore instruction for restoring to a prescribed generation, to create third update information that is update information for a volume that has been updated from a state of the volume of the prescribed generation after receiving the restore information, and to associate the third update information with the difference information for the prescribed generation, and also to delete the update information that existed before receiving the restore instruction, to generate, according to different information for all generations before the prescribed generation, aggregate information in which the difference information for all the generations before the prescribed generation is aggregated and to associate the generated aggregate information with a state of the volume at the oldest stationary point, and to associate the third update information with the generated aggregate information.

5. The storage control apparatus according to claim 4, wherein
the difference information includes area information that indicates a storage area in which data of the volume before a change are stored and data in the storage area after the change; and
the processor extracts, from the difference information for all the generations before the prescribed generation, difference information in descending order of generations from a newer generation, and stores, in the aggregate information, data after a change in the storage area in which the data after the change included in difference information of a generation newer than the extracted difference information do not exist in the aggregate information, among data after the change included in the extracted difference information.

6. A storage control method in which a computer executes a process comprising:
generating, by a processor, according to difference information that represents a difference between stationary points in a volume that represents a management unit for a storage area and that is associated with a plurality of generations, aggregate information in which the difference information for the plurality of generations is aggregated;
associating, by the processor, the aggregate information with a state of the volume at an oldest stationary point; and
associating, by the processor, update information for a volume that has been updated from a state of the volume at a latest stationary point.

7. The storage control method according to claim 6, further comprising:
merging, by the processor, the update information into the aggregate information when an obtaining instruction for obtaining a snapshot at a new stationary point is received;
associating, by the processor, the merged update information with the difference information of a latest generation;
generating, by the processor, update information of a volume that has been updated from a state of the volume at the new stationary point; and
associating, by the processor, the generated update information with the aggregate information.

8. The storage control method according to claim 7, further comprising:
when an obtaining instruction for obtaining a snapshot at a new stationary point is received, generating, by the processor, first update information that is update information for a volume that has been updated from a state of the volume at the new stationary point and associating, by the processor, the first update information with second update information that is the update information that existed before receiving the obtaining instruction, and also setting, by the processor, the second information as read-only;
performing, by the processor, merging of the second update information set as read-only into the aggregate information;
when the merging is completed, cancelling, by the processor, association between the first update information and the second update information, and associating, by the processor, the first update information with the aggregate information; and
when the merging is completed, cancelling, by the processor, association between the second update information and the aggregate information, and associating, by the processor, the second update information with difference information for the latest generation.

9. The storage control method according to claim 8, further comprising:
when a restore instruction for restoring to a prescribed generation is received,
creating, by the processor, third update information that is update information for a volume that has been updated from a state of the volume of the prescribed generation after receiving the restore information,
associating, by the processor, the third update information with the difference information for the prescribed generation,
deleting, by the processor, the update information and aggregate information that existed before receiving the restore instruction,
generating, by the processor and according to different information for all generations before the prescribed generation, aggregate information in which the difference information for all the generations before the prescribed generation is aggregated,
associating, by the processor, the generated aggregate information with a state of the volume at the oldest stationary point, and
associating, by the processor, the third update information with the generated aggregate information.

10. The storage control method according to claim 9, wherein
the difference information includes area information that indicates a storage area in which data of the volume before a change are stored and data in the storage area after the change, and
the storage control method further comprises
extracting, by the processor and from the difference information for all the generations before the prescribed generation, difference information in descending order of generations from a newer generation, and
storing, by the processor and in the aggregate information, data after a change in the storage area in which the data after the change included in difference information of a generation newer than the extracted difference information do not exist in the aggregate information, among data after the change included in the extracted difference information.

11. A non-transitory computer-readable recording medium having stored therein a storage control program causing a computer to execute a process comprising:
generating, according to difference information that represents a difference between stationary points in a volume that represents a management unit for a storage area and that is associated with a plurality of generations, aggregate information in which the difference information for the plurality of generations is aggregated;
associating the aggregate information with a state of the volume at an oldest stationary point; and
associating update information for a volume that has been updated from a state of the volume at a latest stationary point.

12. The non-transitory computer-readable recording medium according to claim 11, the process further comprising:
merging the update information into the aggregate information when an obtaining instruction for obtaining a snapshot at a new stationary point is received;
associating the merged update information with the difference information of a latest generation;
generating update information of a volume that has been updated from a state of the volume at the new stationary point; and
associating the generated update information with the aggregate information.

13. The non-transitory computer-readable recording medium according to claim 12, the process further comprising:
when an obtaining instruction for obtaining a snapshot at a new stationary point is received, generating first update information that is update information for a volume that has been updated from a state of the volume at the new stationary point and associating the first update information with second update information that is the update information that existed before receiving the obtaining instruction, and also setting the second information as read-only;
performing merging of the second update information set as read-only into the aggregate information;
when the merging is completed, cancelling association between the first update information and the second update information, and associating the first update information with the aggregate information; and
when the merging is completed, cancelling association between the second update information and the aggregate information, and associating the second update information with difference information for the latest generation.

14. The non-transitory computer-readable recording medium according to claim 13, the process further comprising:
when a restore instruction for restoring to a prescribed generation is received,
creating third update information that is update information for a volume that has been updated from a state of the volume of the prescribed generation after receiving the restore information,
associating the third update information with the difference information for the prescribed generation,
deleting the update information and aggregate information that existed before receiving the restore instruction,
generating, according to different information for all generations before the prescribed generation, aggregate information in which the difference information for all the generations before the prescribed generation is aggregated,
associating the generated aggregate information with a state of the volume at the oldest stationary point, and
associating the third update information with the generated aggregate information.

15. The non-transitory computer-readable recording medium according to claim 14, wherein
the difference information includes area information that indicates a storage area in which data of the volume before a change are stored and data in the storage area after the change, and
the process further comprises
extracting, from the difference information for all the generations before the prescribed generation, difference information in descending order of generations from a newer generation, and
storing, in the aggregate information, data after a change in the storage area in which the data after the change included in difference information of a generation newer than the extracted difference information do not exist in the aggregate information, among data after the change included in the extracted difference information.

16. The non-transitory computer-readable recording medium according to claim 12, the process further comprising:
when a restore instruction for restoring to a prescribed generation is received,
creating third update information that is update information for a volume that has been updated from a state of the volume of the prescribed generation after receiving the restore information,
associating the third update information with the difference information for the prescribed generation,
deleting the update information and aggregate information that existed before receiving the restore instruction,
generating, according to different information for all generations before the prescribed generation, aggregate information in which the difference information for all the generations before the prescribed generation is aggregated,
associating the generated aggregate information with a state of the volume at the oldest stationary point, and
associating the third update information with the generated aggregate information.

17. The non-transitory computer-readable recording medium according to claim 11, the process further comprising:
when a restore instruction for restoring to a prescribed generation is received,
creating third update information that is update information for a volume that has been updated from a state of the volume of the prescribed generation after receiving the restore information,
associating the third update information with the difference information for the prescribed generation,
deleting the update information and aggregate information that existed before receiving the restore instruction,
generating, according to different information for all generations before the prescribed generation, aggregate information in which the difference information for all the generations before the prescribed generation is aggregated,
associating the generated aggregate information with a state of the volume at the oldest stationary point, and
associating the third update information with the generated aggregate information.

18. The storage control method according to claim 7, further comprising:
when a restore instruction for restoring to a prescribed generation is received,
creating, by the processor, third update information that is update information for a volume that has been updated from a state of the volume of the prescribed generation after receiving the restore information,
associating, by the processor, the third update information with the difference information for the prescribed generation,
deleting, by the processor, the update information and aggregate information that existed before receiving the restore instruction,
generating, by the processor and according to different information for all generations before the prescribed generation, aggregate information in which the difference information for all the generations before the prescribed generation is aggregated,
associating, by the processor, the generated aggregate information with a state of the volume at the oldest stationary point, and
associating, by the processor, the third update information with the generated aggregate information.

19. The storage control method according to claim 6, further comprising:
when a restore instruction for restoring to a prescribed generation is received,
creating, by the processor, third update information that is update information for a volume that has been updated from a state of the volume of the prescribed generation after receiving the restore information,
associating, by the processor, the third update information with the difference information for the prescribed generation,
deleting, by the processor, the update information and aggregate information that existed before receiving the restore instruction,
generating, by the processor and according to different information for all generations before the prescribed generation, aggregate information in which the difference information for all the generations before the prescribed generation is aggregated,
associating, by the processor, the generated aggregate information with a state of the volume at the oldest stationary point, and
associating, by the processor, the third update information with the generated aggregate information.
